(19) United States
(12) Patent Application Publication
(10) Pub. No.: US 2018/0351620 A1
(43) Pub. Date: Dec. 6, 2018

(54) MULTIPLE SOUNDING CHANNEL ESTIMATION

(71) Applicant: QUALCOMM Incorporated, San Diego, CA (US)

(72) Inventors: Chi-Lin SU, Zhubei City (TW); Youhan KIM, San Jose, CA (US); Ning ZHANG, Saratoga, CA (US)

(21) Appl. No.: 15/629,356

(22) Filed: Jun. 21, 2017

Related U.S. Application Data
(60) Provisional application No. 62/513,265, filed on May 31, 2017.

(51) Int. Cl. H04B 7/06; H04B 7/0417

(52) U.S. Cl. CPC H04B 7/0626; H04B 7/0617; H04B 7/0417

(57) ABSTRACT

This disclosure provides systems, methods and apparatus, including computer programs encoded on computer storage media, for combining channel feedback obtained for multiple soundings and transmitting beamformed communications based on the combined channel feedback. In one aspect, a method includes transmitting, by a first wireless device, a first channel sounding using a first subset of antennas, receiving first channel feedback from a second wireless device based on the first channel sounding, transmitting a second channel sounding using a second subset of the antennas that partially overlaps with the first subset, receiving second channel feedback based on the second channel sounding, and transmitting a beamformed communication to the second wireless device based on the first and the second channel feedback.

### PRIORITY DATA

This patent application claims priority to U.S. Provisional Patent Application No. 62/513,265 filed 31 May 2017, entitled “Multiple Sounding Channel Estimation.” The disclosure of the prior application is considered part of and is incorporated by reference in this patent application.

### TECHNICAL FIELD

This disclosure relates generally to wireless medium channel estimation, and more specifically, to channel estimation using multiple channel soundings.

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network (for example, a wireless local area network (WLAN) such as a Wi-Fi network conforming to at least one of the IEEE 802.11 family of standards) may include an access point (AP) that may communicate with at least one station (STA) such as a mobile device. The AP may be coupled to a network, such as the Internet, and may enable a station to communicate via the network including communicating with other devices coupled to the AP.

Beamforming relates to the use of multiple transmit antennas at a transmitting device to generate a pattern of constructive and destructive interference to steer energy toward a receiving device. More specifically, beamforming involves the pre-processing (or precoding) of space-time streams sent to the transmit antennas based on channel response information. In the context of single user (SU) beamforming, the aim is to achieve desirable channel conditions between the transmitting device (the beamformer) and the receiving device (the beamformee). For example, SU beamforming can be used to increase the signal-to-noise ratio (SNR), the throughput, spectral efficiency and the rate over range. In the context of multiple user (MU) Multiple-Input Multiple-Output (MIMO) beamforming, spatial multiplexing is achieved by directing different spatial streams to different devices at spatially diverse locations at the same time.

Both SU and MU-MIMO beamforming rely on explicit channel feedback from the beamformee(s) obtained based on a channel sounding transmitted by the beamformer. To utilize all of the transmit antennas of the beamformer, the beamformee must provide channel feedback for each of the sub-channels corresponding to all of the transmit and receive antenna pairs. However, the number of sub-channels that the beamformee can simultaneously estimate is not necessarily equal to the number of transmit antennas of the beamformer. For example, the number of sub-channels that the beamformee can simultaneously estimate based on a single sounding can generally be limited by the processing capabilities of the beamformee. In such cases, the beamformer is not able to obtain the necessary channel feedback for the entire channel, and as a result, is not able to utilize all of the transmit antennas unless techniques such as spatial expansion are applied.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method includes transmitting, by a first wireless device, a first channel sounding using a first subset of a set of transmit antennas of the first wireless device. The method also includes receiving, by the first wireless device, first channel feedback from a second wireless device based on the first channel sounding. The method also includes transmitting, by the first wireless device, a second channel sounding using a second subset of the set of transmit antennas, the second subset partially overlapping with the first subset. The method additionally includes receiving, by the first wireless device, second channel feedback from the second wireless device based on the second channel sounding. The method further includes transmitting, by the first wireless device, a beamformed communication to the second wireless device based on the first and the second channel feedback.

In some implementations, the method further includes receiving channel estimation capability information from the second device indicating a number NcEc of channels the second wireless device can estimate. In some implementations, each of the first and the second subsets of transmit antennas includes N_{CEC} transmit antennas. In some implementations, the first and the second subsets of transmit antennas share a number N_{OVER} of overlapping transmit antennas, where N_{OVER} is equal to a number N_{R} of receive antennas of the second wireless device. In some implementations, the method further includes determining a number of channel soundings to transmit based on a number N_{T} of transmit antennas of the first wireless device, the number N_{CEC} of channels the second wireless device can estimate, and a number N_{OVER} of overlapping transmit antennas shared between the first and the second subsets of transmit antennas.

In some implementations, the method further includes combining, by the first wireless device, the first and the second channel feedback to generate a combined channel matrix. In some such implementations, combining the first and the second channel feedback includes determining first and second channel matrices for the first and the second channel soundings, respectively, based on the first and the second channel feedback, respectively. In some such implementations, combining the first and the second channel feedback further includes determining overlapping sub-matrices and non-overlapping sub-matrices of the first and the second channel matrices. In some such implementations, combining the first and the second channel feedback further includes applying a QR decomposition operation to each of the overlapping sub-matrices to determine a matrix Q associated with each of the overlapping sub-matrices and to determine a right triangular matrix R. In some such implementations, the combined channel matrix is generated based on the non-overlapping sub-matrices, the Q matrices and the R matrix. In some implementations, the method further includes generating a beamforming steering matrix based on the combined channel matrix, where the beamformed communication is transmitted based on the beamforming steering matrix.

Another innovative aspect of the subject matter described in this disclosure can be implemented in an apparatus. The apparatus includes means for transmitting a first channel sounding using a first subset of a set of transmit antennas. The apparatus also includes means for receiving first channel feedback from a second wireless device based on the first channel sounding. The apparatus also includes means for transmitting a second channel sounding using a second subset of the set of transmit antennas, the second subset partially overlapping with the first subset. The apparatus additionally includes means for receiving second channel feedback from the second wireless device based on the second channel sounding. The apparatus further includes means for transmitting a beamformed communication to the second wireless device based on the first and the second channel feedback.

In some implementations, the apparatus further includes means for receiving channel estimation capability information from the second device indicating a number N_{CEC} of channels the second wireless device can estimate, where each of the first and the second subsets of transmit antennas includes N_{CEC} transmit antennas. In some implementations, the first and the second subsets of transmit antennas share a number N_{OVER} of overlapping transmit antennas, where N_{OVER} is equal to a number N_{R} of receive antennas of the second wireless device. In some implementations, the apparatus further includes means for determining a number of channel soundings to transmit based on a number N_{T} of transmit antennas of the first wireless device, the number N_{CEC} of channels the second wireless device can estimate, and a number N_{OVER} of overlapping transmit antennas shared between the first and the second subsets of transmit antennas.

In some implementations, the apparatus further includes means for combining the first and the second channel feedback to generate a combined channel matrix. In some such implementations, the means for combining the first and the second channel feedback includes means for determining first and second channel matrices for the first and the second channel soundings, respectively, based on the first and the second channel feedback, respectively. In some such implementations, the means for combining the first and the second channel feedback further includes means for determining overlapping sub-matrices and non-overlapping sub-matrices of the first and the second channel matrices. In some such implementations, the means for combining the first and the second channel feedback further includes means for applying a QR decomposition operation to each of the overlapping sub-matrices to determine a matrix Q associated with each of the overlapping sub-matrices and to determine a right triangular matrix R. In some such implementations, the combined channel matrix is generated based on the non-overlapping sub-matrices, the Q matrices and the R matrix. In some implementations, the apparatus further includes means for generating a beamforming steering matrix based on the combined channel matrix, wherein the beamformed communication is transmitted based on the beamforming steering matrix.

Another innovative aspect of the subject matter described in this disclosure can be implemented in a wireless access point. The wireless access point includes a plurality of antennas, a processor, and a memory communicatively coupled with the processor. The memory stores computer-readable code that, when executed by the processor, causes the wireless access point to: transmit a first channel sounding using a first subset of the antennas; receive first channel feedback from a second wireless device based on the first channel sounding; transmit a second channel sounding using a second subset of the antennas, the second subset partially overlapping with the first subset; receive second channel feedback from the second wireless device based on the second channel sounding; and transmit a beamformed communication to the second wireless device based on the first and the second channel feedback.

In some implementations, the wireless access point further includes code to receive channel estimation capability information from the second device indicating a number N_{CEC} of channels the second wireless device can estimate, where each of the first and the second subsets of antennas includes N_{CEC} antennas. In some implementations, the first and the second subsets of antennas share a number N_{OVER} of overlapping antennas, where N_{OVER} is equal to a number N_{R} of receive antennas of the second wireless device. In some implementations, the wireless access point further includes code to determine a number of channel soundings to transmit based on a number N_{T} of antennas of the first wireless device, the number N_{CEC} of channels the second wireless device can estimate, and a number N_{OVER} of overlapping antennas shared between the first and the second subsets of antennas.

In some implementations, the wireless access point further includes code to combine the first and the second channel feedback to generate a combined channel matrix. In some such implementations, the code to combine the first and the second channel feedback includes code to determine first and second channel matrices for the first and the second channel soundings, respectively, based on the first and the second channel feedback, respectively. In some such implementations, the code to combine the first and the second channel feedback further includes code to determine overlapping sub-matrices and non-overlapping sub-matrices of the first and the second channel matrices. In some such implementations, the code to combine the first and the second channel feedback further includes code to apply a QR decomposition operation to each of the overlapping sub-matrices to determine a matrix Q associated with each of the overlapping sub-matrices and to determine a right triangular matrix R. In some such implementations, the combined channel matrix is generated based on the non-overlapping sub-matrices, the Q matrices and the R matrix. In some implementations, the wireless access point further includes code to generate a beamforming steering matrix based on the combined channel matrix, wherein the beamformed communication is transmitted based on the beamforming steering matrix.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless communication system.

FIG. 2 shows a block diagram of an example apparatus for use in wireless communication.

FIG. 3 shows a block diagram of an example apparatus for use in wireless communication.

FIG. 4 shows a block diagram of an example access point (AP) for use in wireless communication.

FIG. 5 shows a block diagram of an example wireless station (STA) for use in wireless communication.

FIG. 6A shows an example frame usable for communications between an AP and each of a number of stations identified by the AP.

FIG. 6B shows an example frame usable for communications between an AP and each of a number of stations identified by the AP.

FIG. 7 shows an example wireless environment including a first wireless device and a second wireless device.

FIG. 8 shows a flowchart illustrating an example process for performing a beamforming operation according to some implementations.

FIG. 9A shows the first wireless device of FIG. 7 transmitting the first channel sounding using the first subset of transmit antennas.

FIG. 9B shows the first wireless device of FIG. 7 transmitting the second channel sounding using the second subset of transmit antennas.

FIG. 10 shows a timing diagram for the example beamforming operation of FIG. 8 according to some implementations.

FIG. 11 shows a flowchart illustrating an example process for transmitting a beamformed transmission according to some implementations.

FIG. 12 shows a flowchart illustrating an example process for combining channel feedback obtained for multiple soundings according to some implementations.

FIGS. 13A-13C show an example wireless environment including a first wireless device and a second wireless device.

FIG. 14 shows a timing diagram for an example beamforming operation usable in the wireless environment of FIGS. 13A-13C according to some implementations.

FIG. 15 shows a flowchart illustrating an example process for performing a multi-user beamforming operation according to some implementations.

FIGS. 16A and 16B show an example multi-user wireless environment including a first wireless device, a second wireless device and a third wireless device.

FIG. 17 shows a timing diagram for the example multi-user beamforming operation of FIG. 15 according to some implementations.

FIG. 18 shows a timing diagram for another example multi-user beamforming operation according to some implementations.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Various implementations relate generally to multiple sounding (also referred to herein as “multi-sounding”) techniques for use in wireless communication. Some implementations more specifically relate to performing a channel sounding operation in which a transmitting device transmits multiple soundings to a receiving device. Particular implementations of the subject matter described in this disclosure can be implemented to realize one or more of the following potential advantages. In some implementations, the described techniques can be used to obtain channel feedback for an entire channel from a receiving device having a channel estimation capability that is less than a number of transmit antennas of the transmitting device. In other words, the described techniques enable the receiving device to provide channel feedback for all the sub-channels between all of the transmit antennas and all of the receive antennas even when the receiving device can estimate only a subset of the sub-channels based on each individual channel sounding. To enable the generation and receipt of such channel feedback, the transmitting device (the beamformer) transmits multiple soundings and the receiving device (the beamformee) obtains and transmits back to the transmitting device channel feedback based on each of the multiple soundings. In some implementations, the multiple sounding techniques can be applied in the context of single user (SU) beamforming or multi-user (MU) Multiple-Input Multiple-Output (MIMO) beamforming. In such beamforming implementations, the beamformer combines the channel feedback obtained for the multiple soundings and generates beamforming coefficients in the form of a steering matrix for use in generating and transmitting beamformed communications to the beamformee(s).

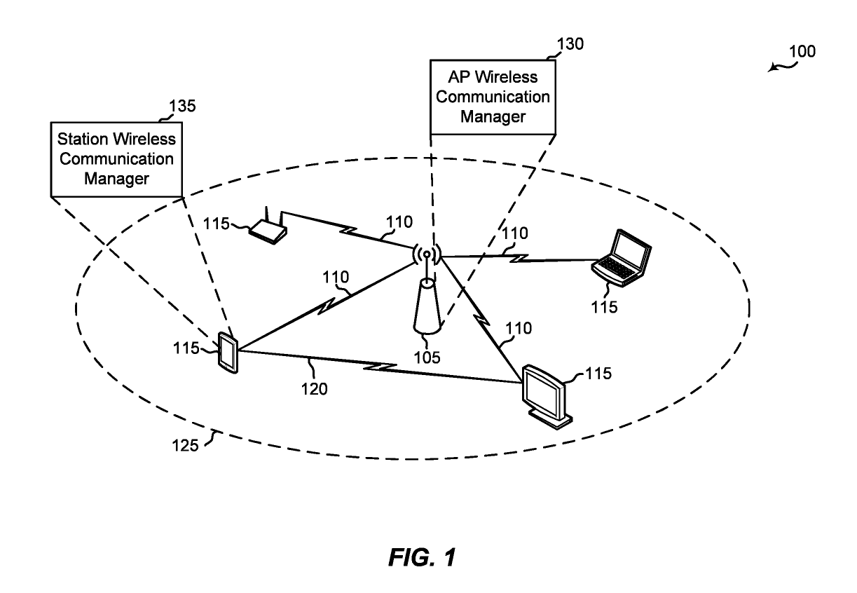

FIG. 1 shows a block diagram of an example wireless communication system 100. In some implementations, the wireless communication system 100 is an example of a wireless local area network (WLAN) (and will hereinafter be referred to as WLAN 100). For example, the WLAN 100 can be a network implementing at least one of the IEEE 802.11 family of standards. In the illustrated implementation, the WLAN network 100 includes an access point (AP) 105 and at least one wireless device or station (STA) 115, such as a mobile device, a personal digital assistant (PDA), another handheld device, a netbook, a notebook computer, a tablet computer, a laptop, a display device (for example, a television (TV), a computer monitor, etc.), or a printer, among other possibilities. While only one AP 105 is illustrated, the WLAN network 100 can include multiple APs 105. Each of the stations 115, which may also be referred to as mobile stations (MSs), mobile devices, access terminals (ATs), user equipments (UEs), subscriber stations (SSs), or subscriber units, may associate and communicate with the AP 105 via a communication link 110. Each AP 105 can have a geographic coverage area 125 such that stations 115 within the geographic coverage area 125 can typically communicate with the AP 105. The stations 115 may be dispersed throughout the geographic coverage area 125. Each station 115 may be stationary or mobile.

Although not shown in FIG. 1, a station 115 can be covered by more than one AP 105 and can associate with different APs 105 at different times for different transmissions. A single AP 105 and an associated set of stations may be referred to as a basic service set (BSS). An extended service set (ESS) may include a set of connected BSSs. A distribution system (DS) (not shown) may be used to connect APs 105 in an extended service set. A geographic coverage area 125 for an AP 105 may be divided into sectors making up only a portion of the coverage area (not shown). The WLAN network 100 may include APs 105 of different types (e.g., metropolitan area, home network, etc.), with varying sizes of coverage areas and overlapping coverage areas for different technologies. Although not shown, other wireless devices also can communicate with the AP 105.

While the stations 115 may communicate with each other through the AP 105 using communication links 110, a station 115 may also communicate directly with another station 115 via a direct wireless link 120. Two or more stations 115 may communicate via a direct wireless link 120 when both stations 115 are in the geographic coverage area 125 of an AP 105, or when one or neither station 115 is within the geographic coverage area 125 of the AP 105. Examples of direct wireless links 120 may include Wi-Fi Direct connections, connections established using a Wi-Fi Tunneled Direct Link Setup (TDLS) link, and other peer-to-peer (P2P) group connections. The stations 115 in these examples may communicate according to a WLAN radio and baseband protocol, including physical and MAC layers, described by the IEEE 802.11 family of standards, including, but not limited to, 802.11b, 802.11g, 802.11a, 802.11n, 802.11ac, 802.11ad, 802.11ah, 802.11ax, etc. In other implementations, other P2P connections and/or ad hoc networks may be implemented within the WLAN network 100.

In the WLAN network 100, an AP 105 may transmit messages to, or receive messages from, at least one station 115 according to various versions of the IEEE 802.11 standard, including those referenced above as well as new wireless standards. In some examples, the AP 105 may include an AP wireless communication manager 130. The AP wireless communication manager 130 may be used to generate and transmit downlink frames and to receive uplink frames. Likewise, a station 115 may include a station wireless communication manager 135. The station wireless communication manager 135 may be used to receive downlink frames and to generate and transmit uplink frames.

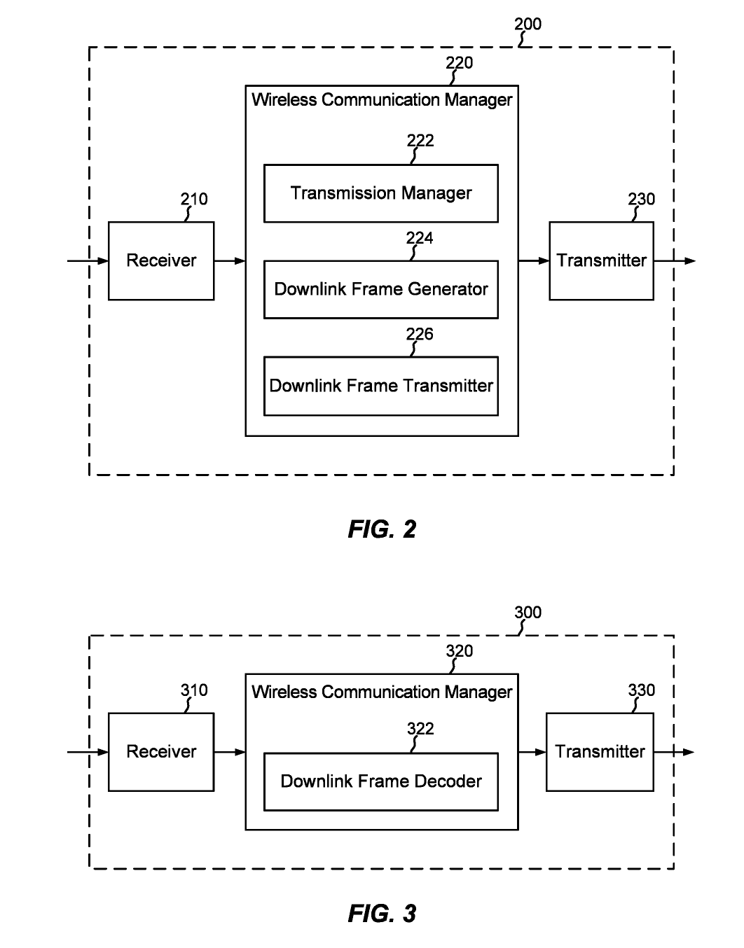

FIG. 2 shows a block diagram of an example apparatus 200 for use in wireless communication. For example, the apparatus 200 may be an example of aspects of the AP 105 described with reference to FIG. 1. The apparatus 200 includes a receiver 210, a wireless communication manager 220, and a transmitter 230, each of which components may be in communication with one another. The components of the apparatus 200 can, individually or collectively, be implemented using at least one application-specific integrated circuit (ASIC) adapted to perform some or all of the applicable functions in hardware. Alternatively, the functions may be performed by at least one processing unit (or core), on at least one integrated circuit. In other examples, other types of integrated circuits may be used (for example, Structured/Platform ASICs, Field Programmable Gate Arrays (FPGAs), a System-on-Chip (SoC), and/or other types of Semi-Custom ICs), which may be programmed in any suitable manner. The functions of each of the components of the apparatus 200 also can be implemented, in whole or in part, with instructions embodied in a memory and formatted to be executed by at least one general and/or application-specific processor.

The receiver 210 can include at least one radio frequency (RF) receiver. The receiver 210 enables the reception of various types of data or control signals (generally referred to hereinafter as “transmissions”) over at least one communication link of a wireless communication system, such as a communication link 110 of the WLAN network 100 described above with reference to FIG. 1. The transmitter 230 can include at least one RF transmitter. The transmitter 230 enables the transmission of various types of data or control signals (transmissions) over at least one communication link of a wireless communication system, again, such as a communication link 110 of the WLAN network 100 described with reference to FIG. 1.

The wireless communication manager 220 illustrated with reference to FIG. 2 may be an example of aspects of the wireless communication manager 130 described above with reference to FIG. 1. The wireless communication manager 220 manages at least one aspect of wireless communication for the apparatus 200. In some implementations, the wireless communication manager 220 can include a transmission manager 222, a downlink frame generator 224, and a downlink frame transmitter 226. In some implementations, part of the downlink frame transmitter 226 may be incorporated into the transmitter 230. The transmission manager 222 identifies a number of stations to receive data from the apparatus 200. The downlink frame generator 224 generates a downlink frame to transmit the data to the stations identified by the transmission manager 222. The downlink frame transmitter 226 is used to transmit, via the transmitter 230, the downlink frame generated by the downlink frame generator 224 to the stations identified by the transmission manager 222.

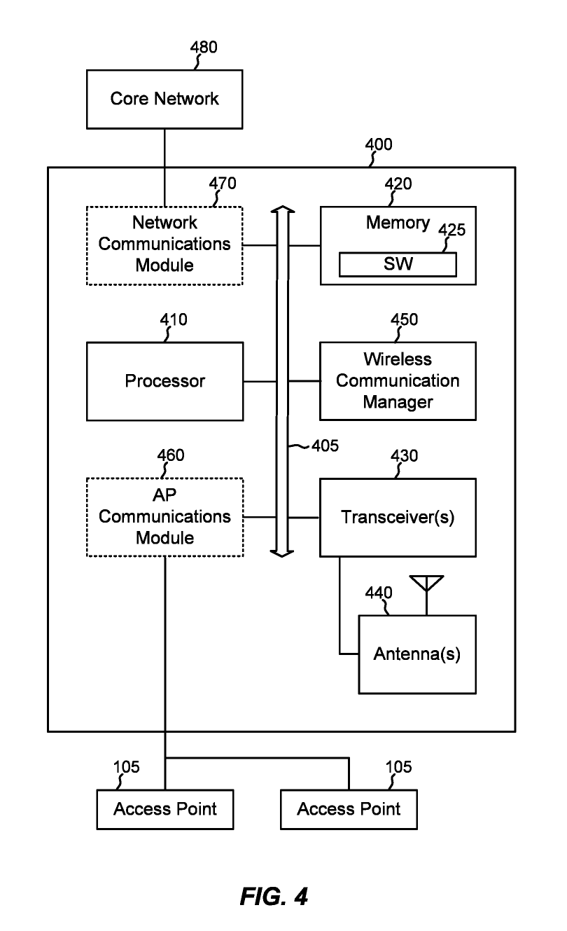

FIG. 3 shows a block diagram of an example apparatus 300 for use in wireless communication. For example, the apparatus 300 may be an example of aspects of the station 115 described with reference to FIG. 1. The apparatus 300 includes a receiver 310, a station wireless communication manager 320, and a transmitter 330, each of which components may be in communication with one another. The components of the apparatus 300 can, individually or collectively, be implemented using at least one ASIC adapted to perform some or all of the applicable functions in hardware. Alternatively, the functions may be performed by at least one other processing unit (or core), on at least one integrated circuit. In other examples, other types of integrated circuits may be used (for example, Structured/Platform ASICs, FPGAs, a SoC, and/or other types of Semi-Custom ICs), which may be programmed in any suitable manner. The functions of each of the components of the apparatus 300 also can be implemented, in whole or in part, with instructions embodied in a memory and formatted to be executed by at least one general and/or application-specific processor.

The receiver 310 can include at least one RF receiver. The receiver 310 enables the reception of various types of data and control signals (transmissions) over at least one communication link of a wireless communication system, such as a communication link 110 of the WLAN network 100 described above with reference to FIG. 1. The transmitter 330 can include at least one RF transmitter. The transmitter 330 enables the transmission of various types of data or control signals (transmissions) over at least one communication link of a wireless communication system, again, such as a communication link 110 of the WLAN network 100 described with reference to FIG. 1.

The wireless communication manager 320 illustrated with reference to FIG. 3 may be an example of aspects of the wireless communication manager 135 described above with reference to FIG. 1. The wireless communication manager 330 manages at least one aspect of wireless communication for the apparatus 300. In some implementations, the wireless communication manager 330 includes a downlink frame decoder 322. In some examples, part of the downlink frame decoder 322 may be incorporated into the receiver 310. The downlink frame decoder 322 receives a downlink frame in a shared radio frequency spectrum band and decodes the data included in the frame using information received in the a signaling field earlier in the frame.

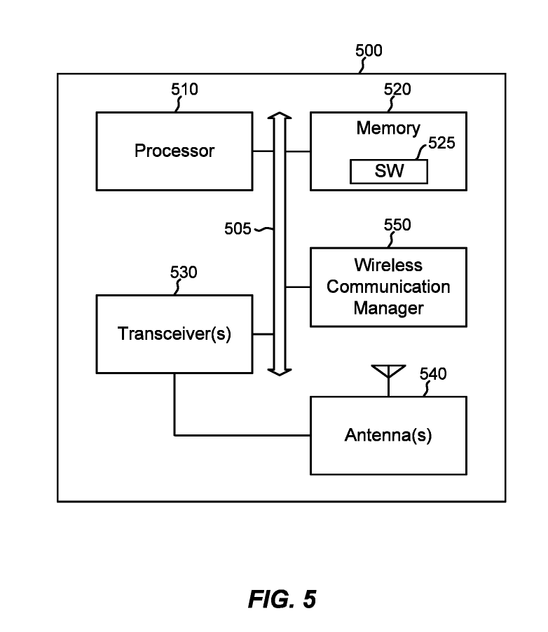

FIG. 4 shows a block diagram of an example access point (AP) 400 for use in wireless communication. For example, the AP 400 may be an example of aspects of the AP 105 described with reference to FIG. 1 or the apparatus 200 described with reference to FIG. 2. As described above, the AP 400 can be configured to send and receive WLAN frames (transmissions) conforming to an IEEE 802.11 standard (such as the 802.11ac or 802.11ax amendments to the 802.11 family of standards), as well as to encode and decode such frames. The AP 400 includes a processor 410, a memory 420, at least one transceiver 430, at least one antenna 440, and a wireless communication manager 450. The wireless communication manager 450 may be an example of aspects of the wireless communication manager 130 described with reference to FIG. 1 or the wireless communication manager 220 described with reference to FIG. 2. In some implementations, the AP 400 also include one or both of an AP communications module 460 and a network communications module 470. Each of the components (or “modules”) described with reference to FIG. 4 can communicate with one another, directly or indirectly, over at least one bus 405.

The memory 420 can include random access memory (RAM) and read-only memory (ROM). The memory 420 also can store computer-readable, computer-executable software (SW) code 425 containing instructions that, when executed by the processor 410, cause the processor to perform various functions described herein for wireless communication, including generation and transmission of a downlink frame and reception of an uplink frame.

The processor 410 can include an intelligent hardware device such as, for example, a central processing unit (CPU), a microcontroller, or an ASIC, among other possibilities. The processor 410 processes information received through the transceiver 430, the communications module 460, and the network communications module 470. The AP processor 410 also can process information to be sent to the transceiver 430 for transmission through the antenna 440, information to be sent to the AP communications module 460, and information to be sent to the network communications module 470. The processor 410 can be configured to handle, alone or in connection with the wireless communication manager 450, various aspects related to generating and transmitting a downlink frame and receiving an uplink frame.

The transceiver 430 can include a modem to modulate packets and provide the modulated packets to the antenna 440 for transmission, as well as to demodulate packets received from the antenna 440. The transceiver 430 can be implemented as at least one transmitter and at least one separate receiver. The transceiver 430 communicates bi-directionally, via the antenna 440, with at least one station 115 as, for example, illustrated in FIG. 1. Although only one transceiver 430 and one antenna 440 are illustrated in FIG. 4, the AP 400 can typically include multiple antennas. For example, in some AP implementations, the AP 400 can include multiple transmit antennas (each with a corresponding transmit chain) and multiple receive antennas (each with a corresponding receive chain). The AP 400 may communicate with a core network 480 through the network communications module 470. The system also may communicate with other APs, such as APs 105, using the AP communications module 460.

The wireless communication manager 450 manages communications with stations and other devices as illustrated in the WLAN network 100 of FIG. 1. In some implementations, the wireless communication manager 450 may be in communication with some or all of the other components of the AP 400 over the bus 405. In some other implementations, functionality of the wireless communication manager 450 can be implemented as a component of the transceiver 430, as a computer program product in the form of computer-readable or processor-executable code or instructions, or as at least one controller element of the processor 410.

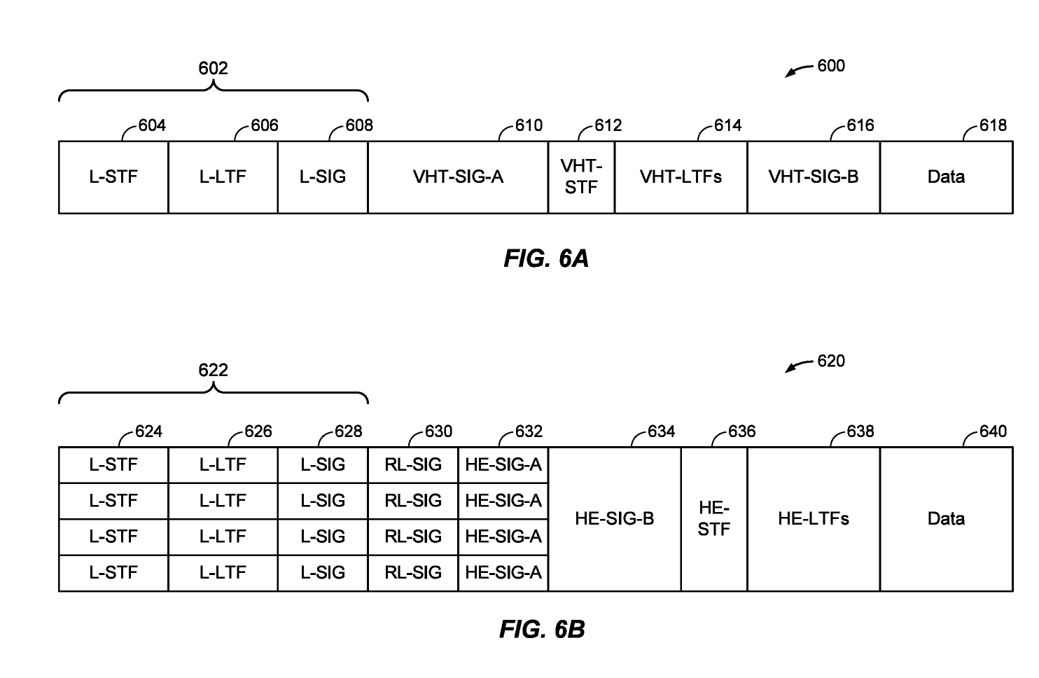

FIG. 5 shows a block diagram of an example wireless station (STA) 500 for use in wireless communication. For example, the STA 500 may be an example of aspects of the STA 115 described with reference to FIG. 1 or the apparatus 300 described with reference to FIG. 3. As described above, the STA 500 can be configured to send and receive WLAN frames (transmissions) conforming to an IEEE 802.11 standard (such as the 802.11ac or 802.11ax amendments to the 802.11 family of standards), as well as to encode and decode such frames. The STA 500 includes a processor 510, a memory 520, at least one transceiver 530, at least one antenna 540, and a wireless communication manager 550. The wireless communication manager 550 may be an example of aspects of the wireless communication manager 135 described with reference to FIG. 1 or the wireless communication manager 320 described with reference to FIG. 3. Each of the components (or “modules”) described with reference to FIG. 5 can communicate with one another, directly or indirectly, over at least one bus 505.

The memory 520 can include RAM and ROM. The memory 520 also can store computer-readable, computer-executable SW code 525 containing instructions that, when executed, cause the processor 510 to perform various functions described herein for wireless communication, including reception of a downlink frame and generation and transmission of an uplink frame.

The processor 510 includes an intelligent hardware device such as, for example, a CPU, a microcontroller, or an ASIC, among other possibilities. The processor 510 processes information received through the transceiver 530 as well as information to be sent to the transceiver 530 for transmission through the antenna 540. The processor 510 can be configured to handle, alone or in connection with the wireless communication manager 550, various aspects related to receiving a downlink frame and generating and transmitting an uplink frame.

The transceiver 530 can include a modem to modulate packets and provide the modulated packets to the antenna 540 for transmission, as well as to demodulate packets received from the antenna 540. The transceiver 530 can be implemented as at least one transmitter and at least one separate receiver. The transceiver 530 communicates bi-directionally, via the antenna 540, with at least one AP 115 as, for example, illustrated in FIG. 1. Although only one transceiver 530 and one antenna 540 are illustrated in FIG. 5, the STA 500 can include two or more antennas.

The wireless communication manager 550 manages communications with APs and other devices as illustrated in the WLAN network 100 of FIG. 1. In some implementations, the wireless communication manager 550 may be in communication with some or all of the other components of the STA 500 over the bus 505. In some other implementations, functionality of the wireless communication manager 550 can be implemented as a component of the transceiver 530, as a computer program product in the form of computer-readable or processor-executable code or instructions, or as at least one controller element of the processor 510.

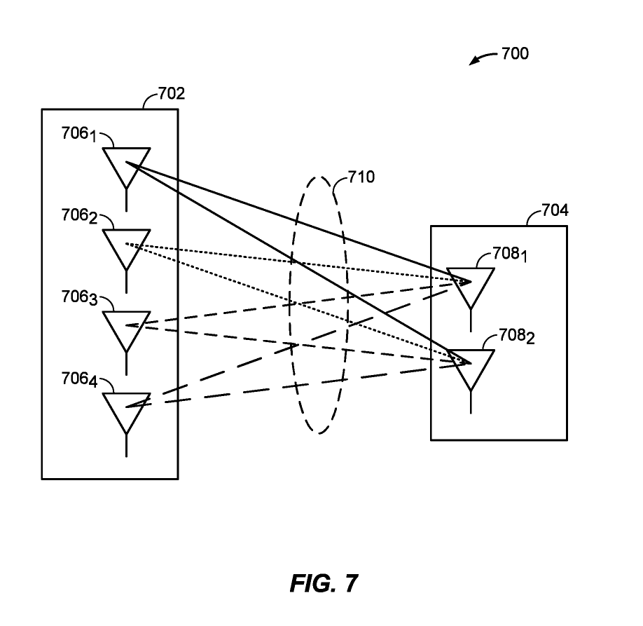

FIG. 6A shows an example frame 600 usable for communications between an AP and each of a number of stations identified by the AP. For example, the frame 600 can be formatted as a very high throughput (VHT) frame in accordance with the IEEE 802.11ac amendment to the IEEE 802.11 set of standards. The frame 600 includes a legacy preamble portion 602 that includes a legacy short training field (L-STF) 604, a legacy long training field (L-LTF) 606, and a legacy signaling field (L-SIG) 608. The frame 600 further includes a non-legacy portion that includes a first very high throughput (VHT) signaling field (VHT-SIG-A) 610, a VHT short training field (VHT-STF) 612, a number of VHT long training fields (VHT-LTFs) 6614, a second VHT signaling field (VHT-SIG-B) 616, and a data field 618.

The VHT-SIG-A field 610 may include VHT WLAN signaling information usable by stations other than the number of stations that are identified to receive downlink communications in the frame 600. The VHT-SIG-A field 610 may also include information usable by the identified number of stations to decode the VHT-SIG-B field 616. The VHT-SIG-B field 616 may include VHT WLAN signaling information usable by the number of stations identified to receive downlink communications in the frame 600. More specifically, the VHT-SIG-B field 616 may include information usable by the number of stations to decode data received in the data field 618. The VHT-SIG-B field 616 may be encoded separately from the VHT-SIG-A field 610. The number of VHT-LTFs 614 depends on the number of transmitted streams.

FIG. 6B shows an example frame 620 usable for communications between an AP and each of a number of stations identified by the AP. For example, the frame 620 can be formatted as a high efficiency (HE) frame in accordance with the IEEE 802.11ax amendment to the IEEE 802.11 set of standards. The frame 620 includes a legacy preamble portion 622 that includes a legacy short training field (L-STF) 624, a legacy long training field (L-LTF) 626, and a legacy signaling field (L-SIG) 628. The frame 620 further includes a non-legacy portion that includes a repeated legacy signaling field (RL-SIG) 630, a first high efficiency signaling field (HE-SIG-A) 632, a second high efficiency signaling field (HE-SIG-B) 634, a high efficiency short training field (HE-STF) 636, a number of high efficiency long training fields (HE-LTFs) 638, and a data field 640.

The frame 620 may be transmitted over a radio frequency spectrum band, which may include a plurality of sub-bands. For example, the radio frequency spectrum band may have a bandwidth of 80 MHz, and each of the sub-bands may have a bandwidth of 20 MHz. When the radio frequency spectrum band includes a plurality of sub-bands, the L-STF, L-LTF, and L-SIG fields 624, 626 and 628, respectively, may be duplicated and transmitted in each of the plurality of sub-bands. The information in the L-SIG field 628 is also duplicated and transmitted in each sub-band of the RL-SIG field 630 as shown in FIG. 6B. The RL-SIG field 630 may indicate to a station that the frame 620 is an IEEE 802.11ax frame.

The HE-SIG-A field 632 may include high efficiency WLAN signaling information usable by stations other than the number of stations that are identified to receive downlink communications in the frame 620. The HE-SIG-A field 632 may also include information usable by the identified number of stations to decode the HE-SIG-B field 634. As shown, when the radio frequency spectrum band includes a plurality of sub-bands, the information included in the HE-SIG-A field 632 may be duplicated and transmitted in each of the plurality of sub-bands.

The HE-SIG-B field 634 may include high efficiency WLAN signaling information usable by the number of stations identified to receive downlink communications in the frame 620. More specifically, the HE-SIG-B field 634 may include information usable by the number of stations to decode data received in the data field 618. The HE-SIG-B field 634 may be encoded separately from the HE-SIG-A field 632.

As described above, various implementations relate generally to multiple sounding techniques for use in wireless communication. Some implementations more specifically relate to performing a channel sounding operation in which a transmitting device transmits multiple soundings to a receiving device. In some implementations, the described techniques can be used to obtain channel feedback for an entire channel from a receiving device having a channel estimation capability that is less than a number of transmit antennas of the transmitting device. In other words, the described techniques enable the receiving device to provide channel feedback for all the sub-channels between all of the transmit antennas and all of the receive antennas even when the receiving device can estimate only a subset of the sub-channels based on each individual channel sounding. To enable the generation and receipt of such channel feedback, the transmitting device (the beamformer) transmits multiple soundings and the receiving device (the beamformee) obtains and transmits back to the transmitting device channel feedback based on each of the multiple soundings. In some implementations, the multiple sounding techniques can be applied in the context of single user (SU) beamforming or multi-user (MU) Multiple-Input Multiple-Output (MIMO) beamforming. In such beamforming implementations, the beamformer combines the channel feedback obtained for the multiple soundings and generates beamforming coefficients in the form of a steering matrix for use in generating and transmitting beamformed communications to the beamformee(s).

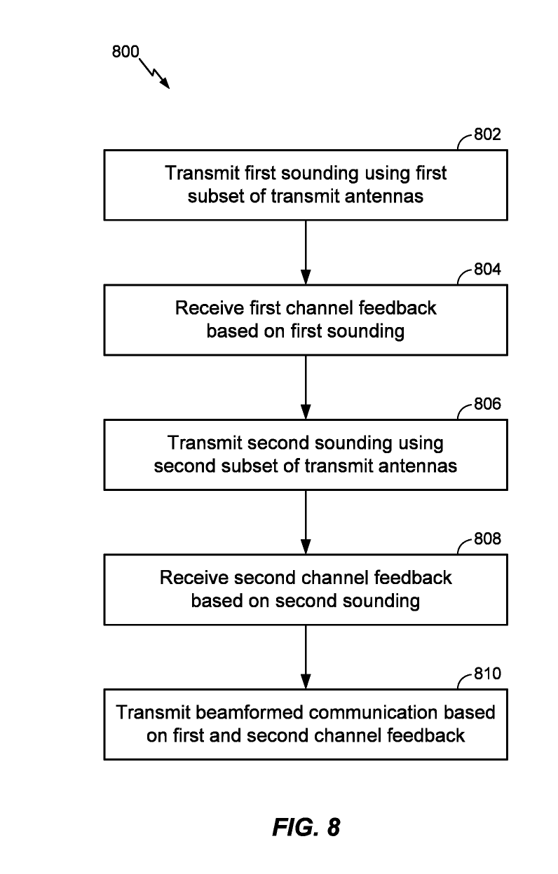

FIG. 7 shows an example wireless environment including a first wireless device 702 and a second wireless device 704. For example, the first wireless device 702 can be an access point (AP) as described above with reference to FIG. 4. The second wireless device 704 can be a station (STA) as described above with reference to FIG. 5. In the example implementation described below, the first wireless device 702 is configured to perform beamforming to transmit a downlink beamformed communication to the second wireless device 704. As such, the first wireless device 702 will hereinafter also be referred to as the beamformer while the second wireless device 704 will hereinafter also be referred to as the beamformee. However, it should be understood that the second wireless device 704 also can be configured to operate as a beamformer to generate and transmit an uplink beamformed communication to the first wireless device 702. For example, not only can an access point transmit a beamformed communication to a station, a station also can be configured to transmit a beamformed communication to an access point.

The first wireless device 702 includes a total number N_{T} of transmit antennas and the second wireless device 704 includes a total number N_{R} of receive antennas enabling the generation of an N_{T} by N_{R} channel. In the particular example shown in FIG. 7, the first wireless device 702 includes four transmit antennas 706₁-706₄, and the second wireless device 704 includes two receive antennas 708₁ and 708₂. The maximum number N_{SS} of spatial streams that the first wireless device 702 can simultaneously transmit to the second wireless device 704 is limited by the lesser of N_{T} and N_{R}. When performing beamforming, the transmitting beamforming array gain is logarithmically proportional to the ratio of N_{T} to N_{SS}. For example, the transmitting beamforming array gain can be represented as equation 1 below.

$${G}_{Array} = 10 * log ( \frac{{N}_{T}}{{N}_{ss}} ) \qquad ( 1 )$$

As such, it is generally desirable, within other constraints, to increase the number N_{T} of transmit antennas when performing beamforming to increase the gain. It is also possible to more accurately direct transmissions by increasing the number of transmit antennas. This is especially advantageous in multi-user transmission contexts in which it is particularly important to reduce inter-user interference.

To utilize all of the transmit antennas of the beamformer (the first wireless device 702 in FIG. 7), the beamformee (the second wireless device 704 in FIG. 7) must provide channel feedback for each of the N_{T}×N_{R} sub-channels corresponding to all of the transmit antenna and receive antenna pairs. To provide the channel feedback, the beamformee is configured to estimate the sub-channels created by the approximately simultaneous transmission of a channel sounding from each of the transmit antennas of the beamformer. However, the channel estimation capability N_{CEC}, the number of sub-channels that the second wireless device 704 can simultaneously estimate, is not necessarily equal to N_{T}. For example, the number N_{CEC} of sub-channels that the second wireless device 704 can simultaneously estimate based on a single sounding (a single sounding including the approximately simultaneous transmission of a sounding from each participating transmit antenna) can generally be limited by the processing capabilities of the second wireless device. In other words, even though the first wireless device 702 can simultaneously transmit a sounding from each of the N_{T} transmit antennas, the second wireless device 704 may be able to only provide channel estimations of a number N_{CEC} of sub-channels that is less than N_{T}.

To further illustrate, FIG. 7 shows a representation of a channel 710 that includes eight sub-channels: one for each combination of a transmit antenna of the first wireless device 702 and a receive antenna of the second wireless device 704. As shown, the second wireless device 704 would ideally be able to estimate four of the eight sub-channels based on the channel information received by each of the receive antennas 708₁ and 708₂ during the sounding operation resulting in an aggregate estimation of all eight sub-channels. In other words, if the number N_{CEC} of sub-channels that can be estimated based on a single sounding is equal to four, then the second wireless device 704 would ideally be able to estimate four sub-channels using each of the receive antennas 708₁ and 708₂, thereby enabling the second wireless device to estimate all eight sub-channels approximately simultaneously. However, if N_{CEC} is less than N_{T}, the second wireless device 704 will not be able to estimate all eight sub-channels based on a single channel sounding. For example, consider the case where N_{CEC} is equal to three. In such case, if all four transmit antennas are used to transmit the sounding, the second wireless device 704 will only be able to estimate three sub-channels using each of the receive antennas 708₁ and 708₂ resulting in an aggregate estimation of only six of the eight sub-channels. The soundings transmitted over the remaining two sub-channels would manifest as noise.

In various implementations, multiple distinct channel soundings can be utilized to estimate the entire channel, enabling the maximum beamforming array gain even in instances in which N_{CEC} is less than N_{T}. In some implementations, the first wireless device 702 learns of the channel estimation capability N_{CEC} of the second wireless device 704 during an association operation or in response to a request for such information sent from the first wireless device to the second wireless device.

As described above, a number N_{SET} of transmit antennas that are used to transmit each of the multiple soundings is limited by the channel estimation capability N_{CEC}. In some implementations, to minimize the total number N_{SOUND} of soundings needed to obtain the complete channel information, the number N_{SET} of transmit antennas that are used to transmit each of the multiple soundings is equal to N_{CEC}. In some such implementations, the total number N_{SOUND} of soundings needed to obtain the complete channel information is dependent on both the channel estimation capability N_{CEC} and the number N_{OVER} of overlapping antennas. For example, in some example implementations, the total number N_{SOUND} of soundings needed to obtain the complete channel information is determined based on equation 2 below.

$${N}_{SOUND} = Ceiling ( \frac{{N}_{T} - {N}_{CEC}}{{N}_{CEC} - {N}_{OVER}} ) + 1 \qquad ( 2 )$$

In some implementations, each set of N_{CEC} transmit antennas used to transmit a respective sounding shares a number N_{OVER} of transmit antennas with another set of N_{CEC} transmit antennas used to transmit another respective sounding. The overlap enables the beamformer to align (or “stitch”) the sounding channels when combining the channel feedback for the multiple soundings. If each set of the transmit antennas used to transmit a respective sounding overlaps with another of the sets of transmit antennas, the full channel can be reconstructed by the beamformer by combining the channel feedback obtained for each of the multiple soundings. More accurate alignment may be achieved by increasing the number N_{OVER} of shared or overlapping antennas. In some implementations, the value of N_{OVER} is equal to the number N_{R} of receive antennas.

Continuing the example above in which the total number N_{T} of transmit antennas is equal to four, the total number N_{R} of receive antennas is equal to two and the channel estimation capability N_{CEC} is equal to three, the full channel can be represented as a channel matrix as shown in equation 3 below.

$$H = [ \begin{matrix}{h}_{11} & {h}_{12} & {h}_{13} & {h}_{14} \\ {h}_{21} & {h}_{22} & {h}_{23} & {h}_{24}\end{matrix} ] \qquad ( 3 )$$

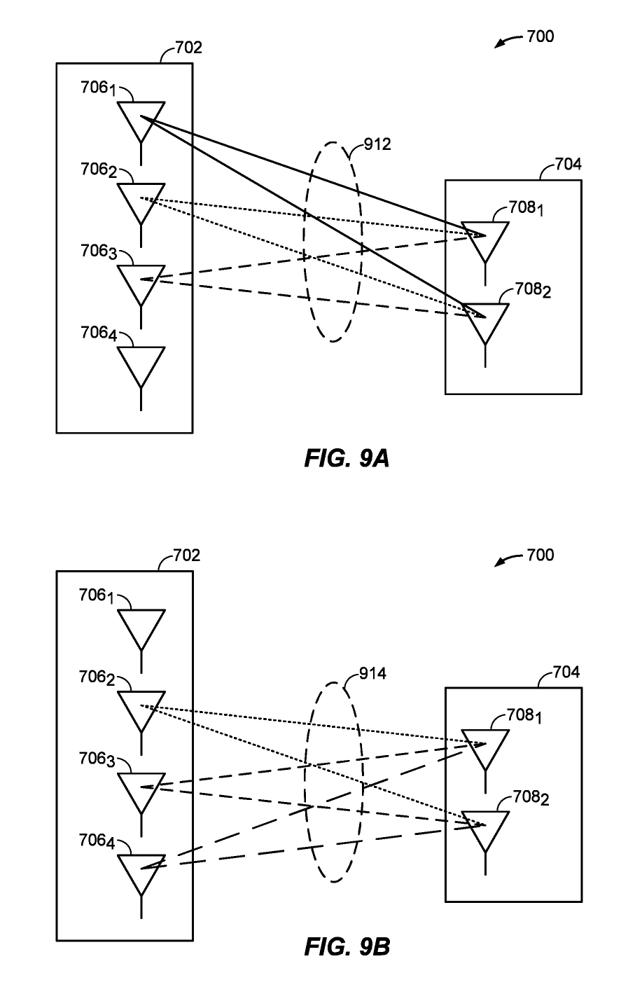

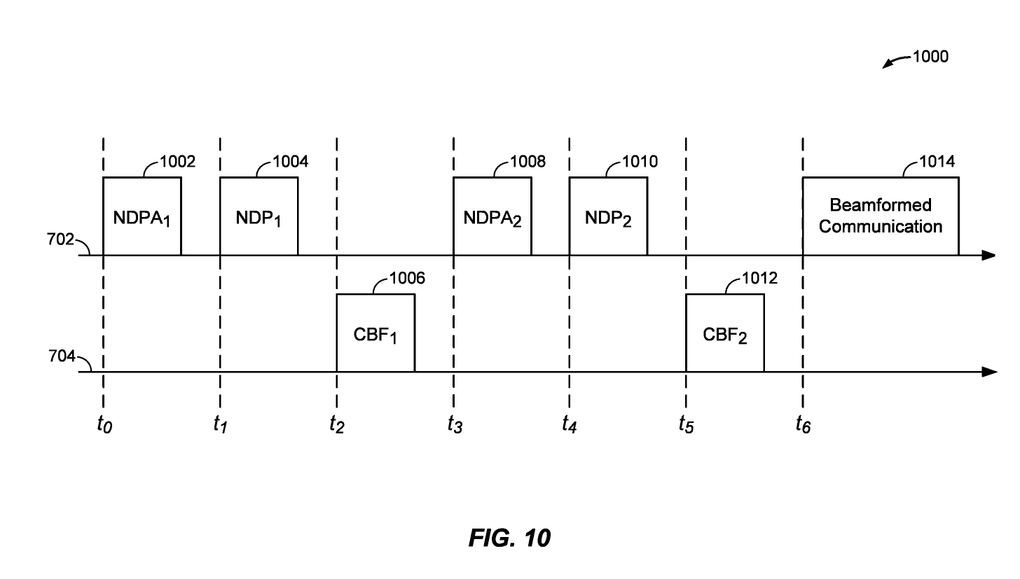

In such an example implementation, two distinct channel soundings can be used to estimate the entire channel. For example, FIG. 8 shows a flowchart illustrating an example process 800 for performing a beamforming operation according to some implementations. The process 800 can be performed by the first wireless device 702 or the second wireless device 704. However, in the present example, the first wireless device 702 is assumed to be operating as the beamformer, while the second wireless device 704 is operating as the beamformee. The process 800 begins in block 802 with the first wireless device 702 transmitting a first channel sounding using a first subset of a set of transmit antennas of the wireless device. FIG. 9A shows the first wireless device 702 of FIG. 7 transmitting the first channel sounding 912 at 802 using the first subset of transmit antennas. In the example shown in FIG. 9A, the first subset of transmit antennas consists of N_{SET}=N_{CEC}=3 transmit antennas 706₁, 706₂ and 706₃, which together form three sub-channels in conjunction with each of the receive antennas 708₁ and 708₂.

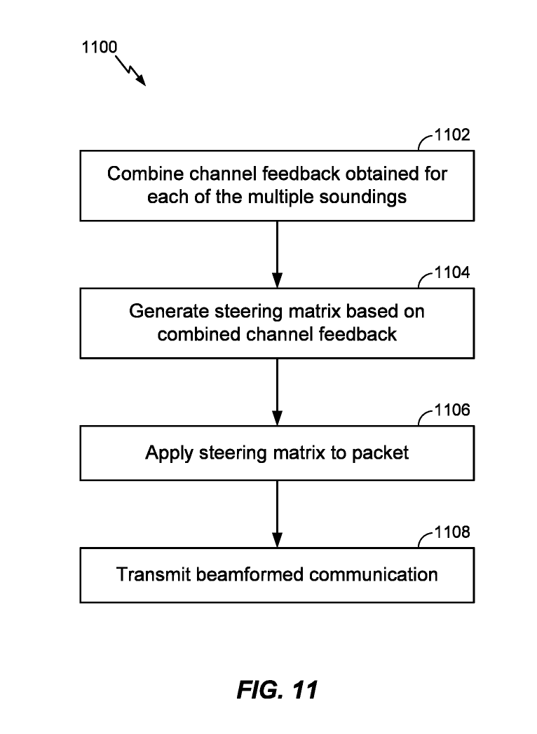

FIG. 10 shows a timing diagram 1000 for the example beamforming operation 800 of FIG. 8 according to some implementations. In the illustrated implementation, the first channel sounding 912 is transmitted as a first null data packet NDP₁ 1004 at time t₁. For example, the NDP₁ 1004 of FIG. 10 can be formatted as a very high throughput (VHT) frame in accordance with the IEEE 802.11ac amendment to the IEEE 802.11 family of standards. In some other implementations, the null data packet NDP₁ can be formatted as a high efficiency (HE) frame in accordance with the IEEE 802.11ax amendment to the IEEE 802.11 family of standards.

In some implementations, although not shown in FIG. 8, the process 800 can additionally include transmitting, by the first wireless device 702, a first NDP announcement frame NDPA₁ to the second wireless device 704 before transmitting the first null data packet NDP₁. For example, FIG. 10 shows an NDPA₁ 1002 transmitted at time t₀ before NDP₁ 1004 is transmitted at time t₁. In such implementations, the NDPA₁ is used by the first wireless device 702 to gain control over the wireless medium and to identify the beamformee(s) and inform them that the NDP₁ 1004 is coming. In the present example, the NDPA₁ 1002 informs the second wireless device 704 that the first wireless device 702 will subsequently transmit a channel sounding, namely, in the form of NDP₁ 1004, and that the second wireless device is to respond to the channel sounding by providing channel feedback.

The beamformee—the second wireless device 704—estimates the channel associated with the NDP₁ 1004 by analyzing the non-legacy LTFs (for example, VHT-LTFs or HE-LTFs) in NDP₁ 1004. The first channel generated by the transmission of the first channel sounding NDP₁ 1004 using transmit antennas 706₁, 706₂ and 706₃ can be represented as a first channel matrix H₁ as shown in equation 4 below.

$${H}_{1} = [ \begin{matrix}{h}_{1 , 11} & {h}_{1 , 12} & {h}_{1 , 13} \\ {h}_{1 , 21} & {h}_{1 , 22} & {h}_{1 , 23}\end{matrix} ] \qquad ( 4 )$$

In some implementations, the second wireless device 704 performs singular value decomposition (SVD) to obtain the first channel feedback it will ultimately transmit back to the first wireless device 702. According to SVD, the first channel matrix H₁ can be represented as equation 5 below, where the symbol * denotes the Hermitian.

$${H}_{1} = {U}_{1} {S}_{1} {V}_{1}^{*} = [ \begin{matrix}{u}_{1 , 11} & {u}_{1 , 12} \\ {u}_{1 , 21} & {u}_{1 , 22}\end{matrix} ] [ \begin{matrix}{s}_{1 , 11} & 0 & 0 \\ 0 & {s}_{1 , 22} & 0\end{matrix} ] \\ [ \begin{matrix}{v}_{1 , 11} & {v}_{1 , 12} & {v}_{1 , 13} \\ {v}_{1 , 21} & {v}_{1 , 22} & {v}_{1 , 23} \\ {v}_{1 , 31} & {v}_{1 , 32} & {v}_{1 , 33}\end{matrix} ] * \qquad ( 5 )$$

In some implementations, the second wireless device 704 performs SVD on the first channel matrix H₁ corresponding to the first channel sounding NDP₁ 1004 and transmits as first channel feedback the values of the S₁ and V₁ matrices to the first wireless device 702. In some implementations, rather than sending the S₁ and V₁ matrices themselves, the second wireless device 704 performs matrix operations to send a representative set of values that can be used by the first wireless device 702 to reconstitute the S₁ and V₁ matrices. For example, in some implementations the second wireless device 704 performs a matrix multiplication operation known as a Givens rotation to calculate angles representative of the S₁ and V₁ matrices. In some implementations, the second wireless device 704 also compresses the angel information into compressed feedback form before transmitting the first channel feedback to the first wireless device 702. FIG. 10 shows the second wireless device 704 transmitting compressed feedback CBF₁ 1006 at time t₂. In some implementations, the compressed feedback CBF₁ 1006 is transmitted in the form of a compressed beamforming report frame. In block 804, the first wireless device 702 receives the first channel feedback CBF₁ from the second wireless device 704.

The process 800 proceeds in block 806 with the first wireless device 702 transmitting a second channel sounding using a second subset of the transmit antennas, the second subset partially overlapping with the first subset. FIG. 9B shows the first wireless device 702 of FIG. 7 transmitting the second channel sounding 914 at 806 using the second subset of transmit antennas. In the example shown in FIG. 9B, the second subset of transmit antennas consists of N_{SET}=N_{CEC}=3 transmit antennas 706₂, 706₃ and 706₄, which together form three sub-channels in conjunction with each of receive antennas 708₁ and 708₂.

In the implementation illustrated in FIG. 10, the second channel sounding 914 is transmitted as a second null data packet NDP₂ 1010 at time t₄. In some implementations, although not shown in FIG. 8, the process 800 can additionally include transmitting, by the first wireless device 702, a second NDP announcement frame NDPA₂ 1008 to the second wireless device 704 at time t₃ before transmitting the second null data packet NDP₂. As described above, the beamformee—the second wireless device 704—estimates the channel associated with the second channel sounding NDP₂ 1010 by analyzing the non-legacy LTFs (for example, VHT-LTFs or HE-LTFs) in NDP₂ 1010. The second channel generated by the transmission of the second channel sounding, NDP₂ 1010, using transmit antennas 706₂, 706₃ and 706₄, can be represented as a second channel matrix H₂ as shown in equation 6 below.

$${H}_{2} = [ \begin{matrix}{h}_{2 , 11} & {h}_{2 , 12} & {h}_{2 , 13} \\ {h}_{2 , 21} & {h}_{2 , 22} & {h}_{2 , 23}\end{matrix} ] \qquad ( 6 )$$

As described above, in some implementations, the second wireless device 704 performs SVD to obtain the second channel feedback it will ultimately transmit back to the first wireless device 702. According to SVD, the second channel matrix H₂ can be represented as equation 7 below.

$${H}_{2} = {U}_{2} {S}_{2} {V}_{2}^{*} = [ \begin{matrix}{u}_{2 , 11} & {u}_{2 , 12} \\ {u}_{2 , 21} & {u}_{2 , 22}\end{matrix} ] [ \begin{matrix}{s}_{2 , 11} & 0 & 0 \\ 0 & {s}_{2 , 22} & 0\end{matrix} ] \\ [ \begin{matrix}{v}_{2 , 11} & {v}_{2 , 12} & {v}_{2 , 13} \\ {v}_{2 , 21} & {v}_{2 , 22} & {v}_{2 , 23} \\ {v}_{2 , 31} & {v}_{2 , 32} & {v}_{2 , 33}\end{matrix} ] * \qquad ( 7 )$$

Again, in some implementations, the second wireless device 704 performs SVD on the second channel H₂ corresponding to the second channel sounding NDP₂ 1008 and transmits as second channel feedback the values of the S₂ and V₂ matrices to the first wireless device 702. And again, in some implementations, rather than sending the S₂ and V₂ matrices themselves, the second wireless device 704 performs matrix operations, such as Givens rotations, to send a representative set of values (for example, angles) that can be used by the first wireless device 702 to reconstitute the S₂ and V₂ matrices. In some implementations, the second wireless device 704 also compresses the angel information into compressed feedback form before transmitting the second channel feedback to the first wireless device 702. FIG. 10 shows the second wireless device 704 transmitting compressed feedback CBF₂ 1012 at time t₅. In some implementations, the compressed feedback CBF₂ 1012 is transmitted in the form of a compressed beamforming report frame. In block 808, the first wireless device 702 receives the second channel feedback CBF₂ from the second wireless device 704.

The process 800 proceeds in block 810 with the first wireless device 702 transmitting a beamformed communication to the second wireless device 704 based on the first and the second channel feedback CBF₁ and CBF₂, respectively. FIG. 10 shows the first wireless device 704 transmitting the beamformed communication 1014 at time t₆. In some implementations, transmitting the beamformed communication to the second wireless device 704 in block 810 involves combining the first and the second channel feedback and generating the beamformed communication based on the combined channel feedback.

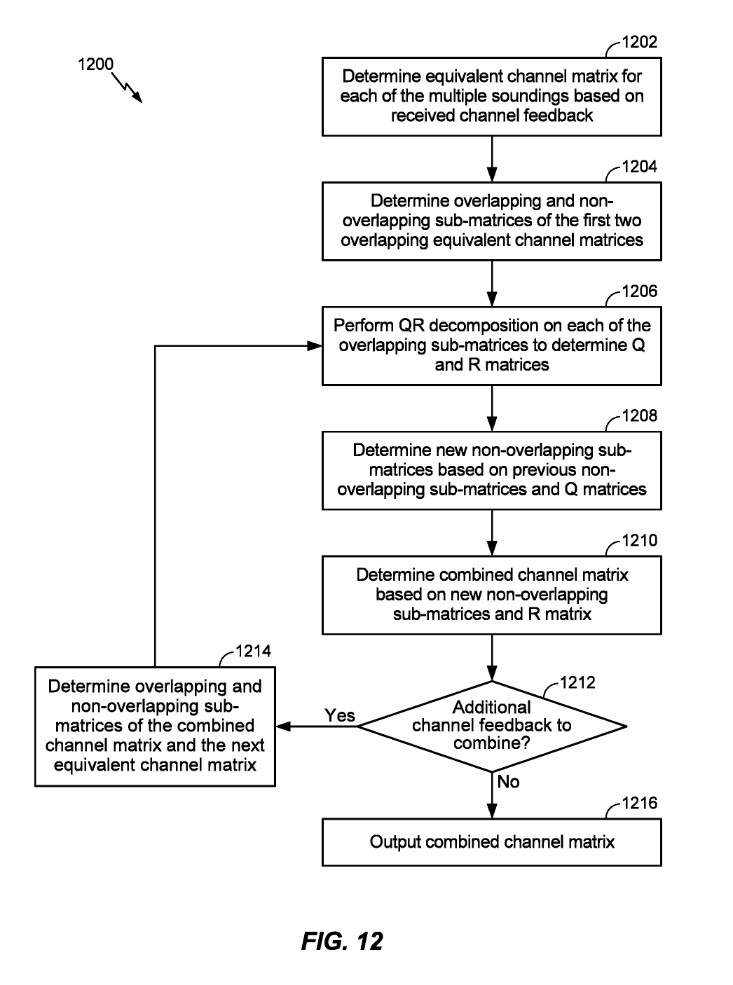

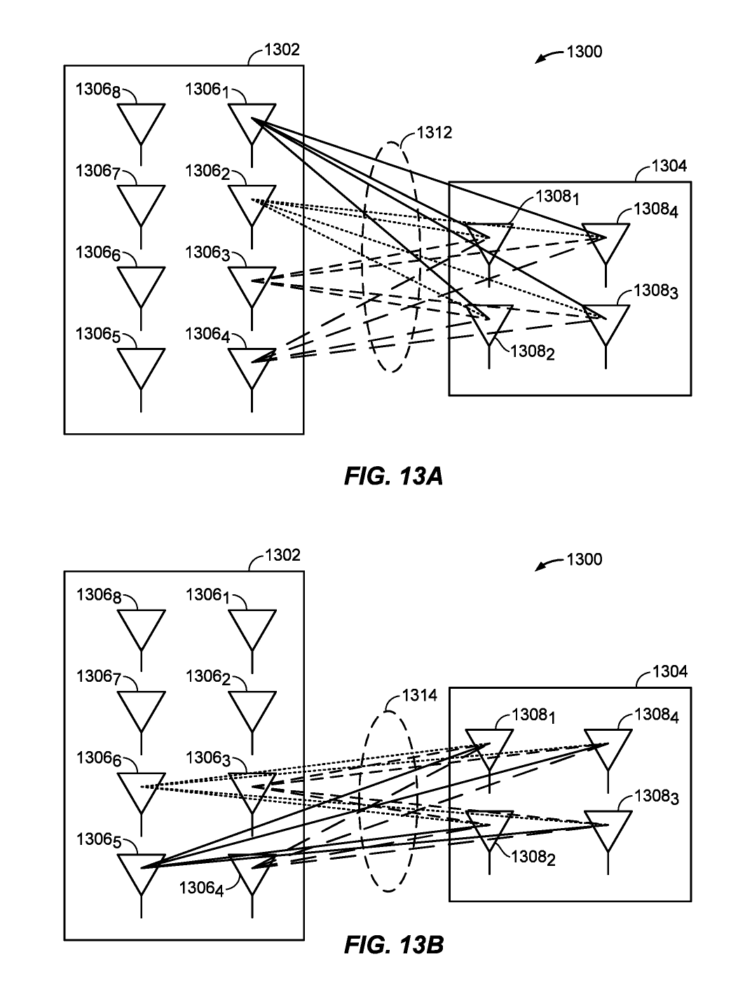

FIG. 11 shows a flowchart illustrating an example process 1100 for transmitting a beamformed communication according to some implementations. For example, the process 1100 can implement block 810 in the process 800 of FIG. 8. The process 1100 begins in block 1102 with combining the channel feedback obtained for each of the multiple soundings. For example, continuing the example above, to combine the channel feedback the first wireless device 702 would combine the first channel feedback CBF₁ and the second channel feedback CBF₂ to obtain combined channel feedback in the form of, for example, a combined channel matrix H_{Comb}. In some implementations, to combine the channel feedback the first wireless device 702 is configured to perform a QR decomposition operation as described below with reference to FIG. 12.

In some implementations, the process 1100 proceeds in block 1104 with generating a steering matrix based on the combined channel H_{Comb}. For example, in some implementations, to generate the steering matrix in block 1104 the first wireless device 702 can be configured to perform SVD on the combined channel matrix H_{Comb}. The first wireless device 702 then applies the steering matrix to the current packet in block 1106 and transmits the beamformed communication in block 1108. For example, the steering matrix can be applied starting from the legacy short training field L-STF and continuing through the DATA field of the OFDM packet. In some other implementations, the steering matrix can be applied starting from a non-legacy portion of the preamble, for example, beginning with the VHT-STF or HE-STF.

FIG. 12 shows a flowchart illustrating an example process 1200 for combining channel feedback obtained for multiple soundings according to some implementations. For example, the process 1200 can be performed by the beamformer to implement block 1102 in the process 1100 of FIG. 11. The process 1200 begins in block 1202 with determining an equivalent channel matrix for each of the multiple soundings based on the corresponding channel feedback received for the respective sounding. In some implementations, each equivalent channel matrix is determined based on the corresponding S and V matrices received for the respective sounding. For example, the n^{th} equivalent channel matrix H_{EQn} can be obtained as the product of the n^{th} S matrix and the n^{th} V matrix as shown in equation 8 below.

$${H}_{EQn} = [ \begin{matrix}{\tilde{h}}_{n , 11} & {\tilde{h}}_{n , 12} & {\tilde{h}}_{n , 13} \\ {\tilde{h}}_{n , 21} & {\tilde{h}}_{n , 22} & {\tilde{h}}_{n , 23}\end{matrix} ] = [ \begin{matrix}{s}_{n , 11} & 0 & 0 \\ 0 & {s}_{n , 22} & 0\end{matrix} ] \\ [ \begin{matrix}{v}_{n , 11} & {v}_{n , 12} & {v}_{n , 13} \\ {v}_{n , 21} & {v}_{n , 22} & {v}_{n , 23} \\ {v}_{n , 31} & {v}_{n , 32} & {v}_{n , 33}\end{matrix} ] * = {S}_{n} {V}_{n}^{*} \qquad ( 8 )$$

The process 1200 proceeds in block 1204 with determining the overlapping and non-overlapping sub-matrices of the first two overlapping equivalent channel matrices.

H_{EQ1}=[H_{1,1}H_{1,2}] (9)

H_{EQ2}=[H_{2,1}H_{2,2}] (10)

where the non-overlapping sub-matrices are

$${H}_{1 , 1} = [ \begin{matrix}{\tilde{h}}_{1 , 11} \\ {\tilde{h}}_{1 , 21}\end{matrix} ] and$$

$${H}_{2 , 2} = [ \begin{matrix}{\tilde{h}}_{2 , 13} \\ {\tilde{h}}_{2 , 23}\end{matrix} ]$$

and where the overlapping sub-matrices are

$${H}_{1 , 2} = [ \begin{matrix}{\tilde{h}}_{1 , 12} & {\tilde{h}}_{1 , 13} \\ {\tilde{h}}_{1 , 22} & {\tilde{h}}_{1 , 23}\end{matrix} ] and$$

$${H}_{2 , 1} = [ \begin{matrix}{\tilde{h}}_{2 , 11} & {\tilde{h}}_{2 , 12} \\ {\tilde{h}}_{2 , 21} & {\tilde{h}}_{2 , 22}\end{matrix} ] .$$

In block 1206, the beamformer performs QR decomposition on each of the overlapping sub-matrices to determine the corresponding Q and R matrices. The QR decomposition of the overlapping sub-matrices can be defined as equations 11 and 12 below.

H_{1,2}=Q₁R (11)

H_{2,1}=Q₂R (12)

The process 1200 proceeds in block 1208 with determining new non-overlapping sub-matrices based on the previous non-overlapping sub-matrices and the corresponding Q₁ and Q₂ matrices. The new non-overlapping sub-matrices can be obtained using equations 13 and 14 below.

H_{New1,1}=Q₁*H_{1,1} (13)

H_{New2,2}=Q₂*H_{2,2} (14)

In block 1210, the beamformer determines a combined channel matrix H_{Comb} based on the new non-overlapping sub-matrices and the right triangular R matrix as shown in equation 15 below.

H_{Comb}=[H_{New1,1}RH_{New2,2}] (15)

In some implementations, the process 1200 proceeds in block 1212 with determining whether there is any additional channel feedback to combine. If the beamformer determines in block 1212 that there is additional channel feedback to combine, the process 1200 proceeds to block 1214 with determining the overlapping and non-overlapping sub-matrices of the current combined channel matrix H_{Comb} and the next equivalent channel matrix (for example, H_{EQ3}). The process 1200 then proceeds back to block 1206 with performing QR decomposition on each of the new overlapping sub-matrices of the current combined channel matrix H_{Comb} and the next equivalent channel matrix to determine new Q and R matrices. The process 1200 cycles through blocks 1214, 1206, 1208 and 1210 until the beamformer determines in block 1212 that there is no additional channel feedback to combine, at which time the process 1200 proceeds to block 1216 with outputting the final combined channel matrix H_{Comb}. The final combined channel matrix H_{Comb} output in block 1216 can then be used, for example, in block 1104 of the process 1100 described with reference to FIG. 11.

The example shown and described with reference to FIGS. 7-10 was described in the context of a wireless environment in which the total number N_{T} of transmit antennas was equal to four, the total number N_{R} of receive antennas was equal to two, the channel estimation capability N_{CEC} was equal to three, and two distinct soundings were used to estimate the entire channel. However, as is evident from the process 1200 described with reference to FIG. 12, the implementations described herein can be applied in other contexts including wireless environments in which the total number N_{T} of transmit antennas is greater than or less than four, the total number N_{R} of receive antennas is greater than or less than two, the channel estimation capability N_{CEC} is greater than or less than three, and more than two distinct soundings can be used to estimate the entire channel.

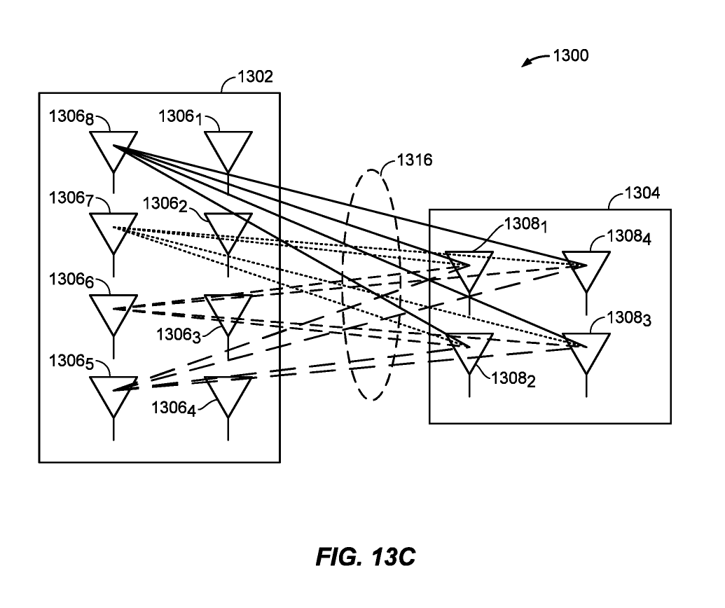

FIGS. 13A-13C show an example wireless environment 1300 including a first wireless device 1302 and a second wireless device 1304. For example, the first wireless device 1302 can be an access point (AP) as described above with reference to FIG. 4. The second wireless device 1304 can be a station (STA) as described above with reference to FIG. 5. In the example implementation described below, the first wireless device 1302 is configured to perform beamforming to transmit a downlink beamformed communication to the second wireless device 1304. As such, the first wireless device 1302 will hereinafter also be referred to as the beamformer while the second wireless device 1304 will hereinafter also be referred to as the beamformee.

In the particular example shown in FIGS. 13A-13C, the first wireless device 1302 includes eight transmit antennas 1306₁-1306₈, the second wireless device 1304 includes four receive antennas 1308₁-1308₄, and the channel estimation capability N_{CEC} of the second wireless device is equal to four. In such an environment, a multi-sounding operation including three distinct soundings can be used to estimate the entire channel. FIG. 13A shows the first wireless device 1302 transmitting the first channel sounding 1312 using the first subset of transmit antennas. In the illustrated example, the first subset of transmit antennas consists of N_{SET}=N_{CEC}=4 transmit antennas 1306₁-1306₄, which together form four sub-channels in conjunction with each of the four receive antennas 1308₁-1308₄.

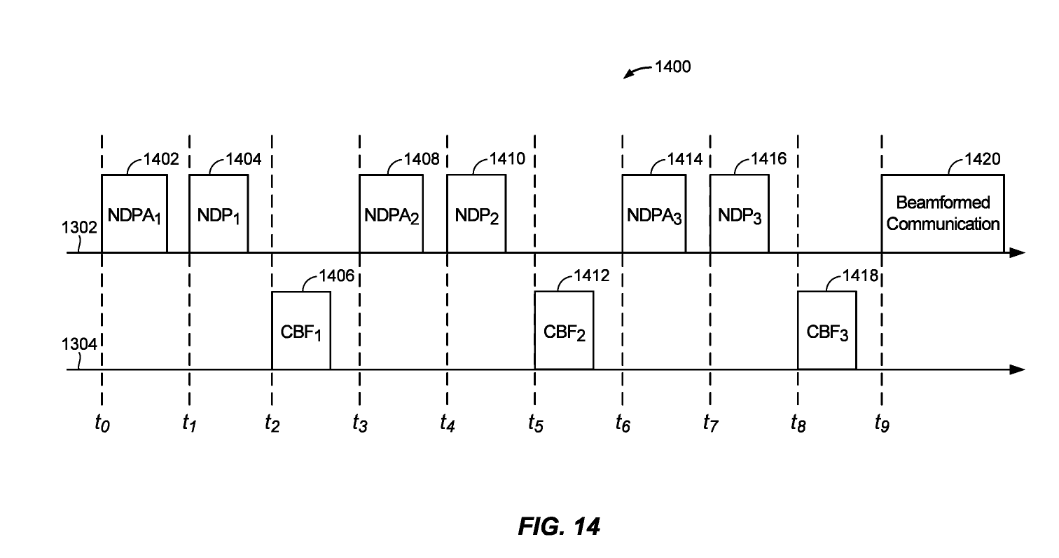

FIG. 14 shows a timing diagram 1400 for an example beamforming operation usable in the wireless environment of FIGS. 13A-13C according to some implementations. As described above, the beamforming operation can include transmitting, by the first wireless device 1302, a first NDP announcement frame NDPA₁ 1402 to the second wireless device 1304 at time t₀. The beamforming operation proceeds with the first wireless device 1302 transmitting a first channel sounding using the first subset of the transmit antennas 1306₁-1306₄. In the illustrated implementation, the first channel sounding is transmitted as a first null data packet NDP₁ 1404 at time t₁. The beamformee—the second wireless device 1304—estimates the channel associated with the NDP₁ 1404 by analyzing the non-legacy LTFs (for example, VHT-LTFs or HE-LTFs) in NDP₁ 1404. In some implementations, the second wireless device 1304 performs SVD on the first channel H₁ corresponding to the first channel sounding NDP₁ 1404 and transmits as first channel feedback the values of the S₁ and V₁ matrices to the first wireless device 1302 in a compressed form as described above. FIG. 14 shows the second wireless device 1304 transmitting compressed feedback CBF₁ 1406 at time t₂. In some implementations, the compressed feedback CBF₁ 1406 is transmitted in the form of a compressed beamforming report frame.

The beamforming operation can include transmitting, by the first wireless device 1302, a second NDP announcement frame NDPA₂ 1408 to the second wireless device 1304 at time t₃. The beamforming operation proceeds with the first wireless device 1302 transmitting a second channel sounding using a second subset of the transmit antennas, the second subset partially overlapping with the first subset. FIG. 13B shows the first wireless device 1302 transmitting the second channel sounding 1314 using the second subset of transmit antennas. In the example shown in FIG. 13B, the second subset of transmit antennas consists of N_{SET}=N_{CEC}=4 transmit antennas 1306₃-1306₆, which together form four sub-channels in conjunction with each of the four receive antennas 1308₁-1308₄. In the implementation illustrated in FIG. 14, the second channel sounding is transmitted as a second null data packet NDP₂ 1410 at time t₄. As described above, the beamformee—the second wireless device 1304—estimates the channel associated with the NDP₂ 1410 by analyzing the non-legacy LTFs (for example, VHT-LTFs or HE-LTFs) in NDP₂ 1410. In some implementations, the second wireless device 1304 performs SVD on the second channel H₂ corresponding to the second channel sounding NDP₂ 1410 and transmits as second channel feedback the values of the S₂ and V₂ matrices to the first wireless device 1302 in a compressed form as described above. FIG. 14 shows the second wireless device 1304 transmitting compressed feedback CBF₂ 1412 at time t₅. In some implementations, the compressed feedback CBF₂ 1412 is transmitted in the form of a compressed beamforming report frame.

The beamforming operation can include transmitting, by the first wireless device 1302, a third NDP announcement frame NDPA₃ 1414 to the second wireless device 1304 at time t₆. The beamforming operation proceeds with the first wireless device 1302 transmitting a third channel sounding using a third subset of the transmit antennas, the third subset partially overlapping with the second subset. FIG. 13C shows the first wireless device 1302 transmitting the third sounding 1316 using the third subset of transmit antennas. In the example shown in FIG. 13C, the third subset of transmit antennas consists of N_{SET}=N_{CEC}=4 transmit antennas 1306₅-1306₈, which together form four sub-channels in conjunction with each of the four receive antennas 1308₁-1308₄. In the implementation illustrated in FIG. 14, the third sounding is transmitted as a third null data packet NDP₃ 1416 at time t₇. As described above, the beamformee—the second wireless device 1304—estimates the channel associated with the NDP₃ 1416 by analyzing the non-legacy LTFs (for example, VHT-LTFs or HE-LTFs) in NDP₃ 1416. In some implementations, the second wireless device 1304 performs SVD on the third channel H3 corresponding to the third sounding NDP₃ 1416 and transmits as third channel feedback the values of the S₃ and V₃ matrices to the first wireless device 1302 in a compressed form as described above. FIG. 14 shows the second wireless device 1304 transmitting compressed feedback CBF₃ 1418 at time t₈. In some implementations, the compressed feedback CBF₃ 1418 is transmitted in the form of a compressed beamforming report frame.

The beamforming operation proceeds with the first wireless device 1302 transmitting a beamformed communication to the second wireless device 1304 based on the first, the second and the third channel feedback CBF₁, CBF₂ and CBF₃, respectively. FIG. 14 shows the first wireless device 1302 transmitting the beamformed communication 1420 at time t₉. As described above, transmitting the beamformed communication to the second wireless device 1304 involves combining the first, the second and the third channel feedback and generating the beamformed communication based on the combined channel feedback. For example, the process 1100 can be applied to transmit the beamformed communication according to some implementations. As is also described above, in some implementations, to combine the channel feedback the first wireless device 1302 is configured to perform a QR decomposition operation as described above with reference to FIG. 12.

The preceding examples were described in the context of single-user (SU) operation, and specifically, in the context of SU beamforming. However, the implementations described herein can be applied in multi-user (MU) contexts including MU-MIMO beamforming. In MU-MIMO beamforming implementations, each beamformee responds to the multiple channel soundings with channel feedback and the beamformer constructs one master steering matrix based on all the channel feedback from all of the beamformees. The multiple user transmissions are combined together in the spatial mapper, which applies the master steering matrix to the collective data of all users.

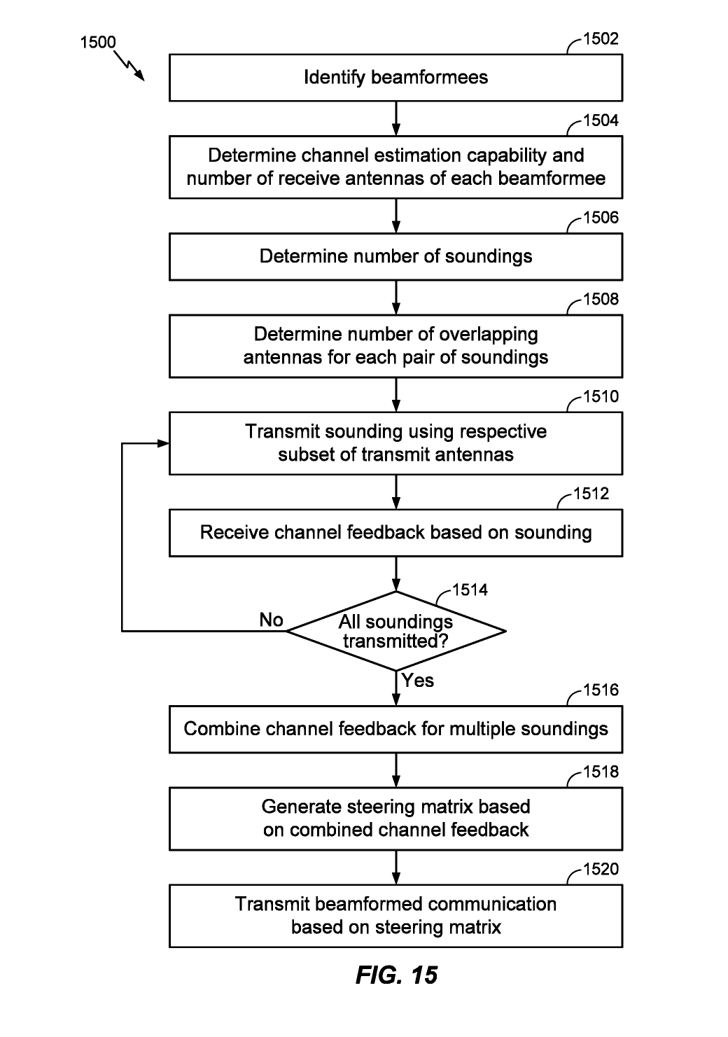

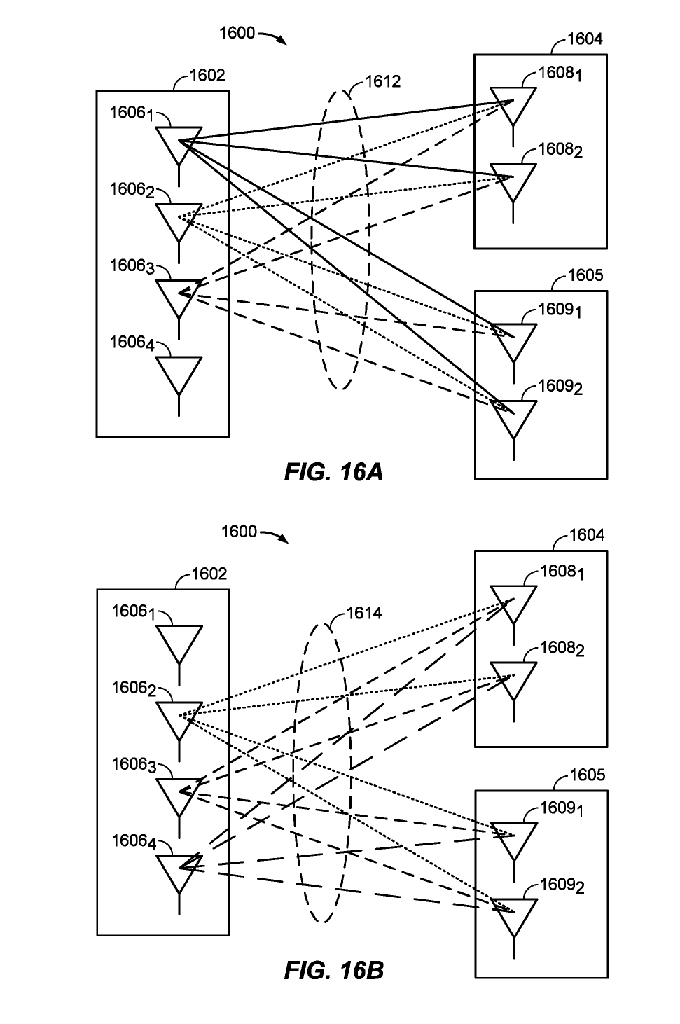

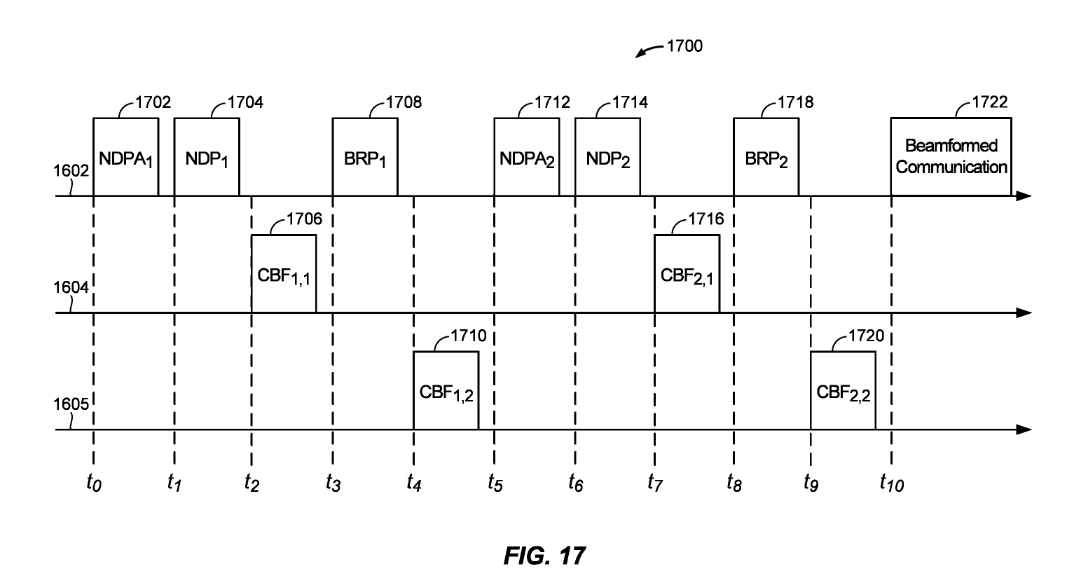

FIG. 15 shows a flowchart illustrating an example process 1500 for performing a multi-user beamforming operation according to some implementations. FIGS. 16A and 16B show an example multi-user wireless environment 1600 including a first wireless device 1602, a second wireless device 1604 and a third wireless device 1605. FIG. 17 shows a timing diagram 1700 for the example beamforming operation 1500 of FIG. 15 according to some implementations.

In the particular example shown in FIGS. 16A and 16B, the first wireless device 1602 includes four transmit antennas 1606₁-1606₄, the second wireless device 1604 includes two receive antennas 1608₁ and 1608₂, and the third wireless device 1605 includes two receive antennas 1609₁ and 1609₂. For example, the first wireless device 1602 can be an access point (AP) as described above with reference to FIG. 4. The second and third wireless devices 1604 and 1605, respectively, can each be a station (STA) as described above with reference to FIG. 5. In the example implementation described below, the first wireless device 1602 is configured to perform beamforming to transmit a downlink beamformed transmission to each of the second wireless device 1604 and the third wireless device 1605. As such, the first wireless device 1602 will hereinafter also be referred to as the beamformer while the second and third wireless devices 1604 and 1605 will hereinafter also be referred to as beamformees.

In some implementations, the process 1500 begins in block 1502 with the first wireless device 1602 identifying the beamformees, which, in the illustrated example, are the second wireless device 1604 and the third wireless device 1605. The process 1500 proceeds in block 1504 with the first wireless device 1602 determining the channel estimation capabilities and the number of receive antennas of each of the identified beamformees. In this example, the channel estimation capability N_{CEC} of the second wireless device 1604 is equal to three and the channel estimation capability N_{CEC} of the third wireless device 1605 is equal to three. In some implementations, the first wireless device 1602 then determines in block 1506 the number of channel soundings required to obtain all of the necessary channel feedback. The process 1500 proceeds in block 1508 with the first wireless device 1602 determining the number N_{OVER} of overlapping antennas for each pair of soundings. In such an environment as illustrated in FIGS. 16A and 16B, a multi-sounding operation including three distinct channel soundings with N_{OVER}=2 can be used to estimate the entire MIMO channel.

In block 1510, the first wireless device 1602 transmits the next channel sounding (in this case the first channel sounding) using the respective subset of transmit antennas. FIG. 16A shows the first wireless device 1602 transmitting the first channel sounding 1612 using the first subset of transmit antennas. In the illustrated example, the first subset of transmit antennas consists of N_{SET}=N_{CEC}=3 transmit antennas 1606₁-1606₃, which together form three sub-channels in conjunction with each of the two receive antennas 1608₁ and 1608₂ of the second wireless device 1604 and each of the two receive antennas 1609₁ and 1609₂ of the third wireless device 1605. In the implementation illustrated in FIG. 17, the first channel sounding is transmitted as a first null data packet NDP₁ 1704 at time t₁. As described above, in some implementations, although not shown in FIG. 15, the process 1500 can additionally include transmitting, by the first wireless device 1602, a first NDP announcement frame NDPA₁ before transmitting the first null data packet NDP₁. For example, FIG. 17 shows an NDPA₁ 1702 transmitted at time to before NDP₁ 1704 is transmitted at time t₁.

In block 1512, the first wireless device 1602 receives the channel feedback from the second and the third wireless devices 1604 and 1605, respectively. As described above, each of the beamformees—the second and the third wireless devices 1604 and 1605—estimates the channel associated with the NDP₁ 1704 by analyzing the non-legacy LTFs in NDP₁ 1704. As is also described above, in some implementations, the second and the third wireless devices 1604 and 1605, respectively, perform SVD on the channels corresponding to the first channel sounding NDP₁ 1704 and transmit as first channel feedback the values of the S and V matrices to the first wireless device 1602 in a compressed form. FIG. 17 shows the second wireless device 1604 transmitting compressed feedback CBF_{1,1} 1706 at time t₂. In some implementations, the compressed feedback CBF_{1,1} 1706 is transmitted in the form of a compressed beamforming report frame. To obtain the channel feedback from the third wireless device 1605, the first wireless device 1602 transmits a beamforming report poll frame BRP₁ 1708 at time t₃. In response to the beamforming report poll frame BRP₁ 1708, the third wireless device 1605 transmits compressed feedback CBF_{1,2} 1710 at time t₄.

The process 1500 proceeds in block 1514 with the first wireless device 1602 determining whether all of the multiple soundings have been transmitted. If the first wireless device 1602 determines, in block 1514, that all soundings have not been transmitted, the process 1500 proceeds back to block 1510 with the first wireless device transmitting a next channel sounding using a next subset of the transmit antennas, the next subset partially overlapping with the previous subset. FIG. 16B shows the first wireless device 1602 transmitting a second channel sounding 1614 using the second subset of transmit antennas. In the example shown in FIG. 16B, the second subset of transmit antennas consists of N_{SET}=N_{CEC}=3 transmit antennas 1606₂-1606₄, which together form three sub-channels in conjunction with each of the two receive antennas 1608₁ and 1608₂ of the second wireless device 1604 and each of the two receive antennas 1609₁ and 1609₂ of the third wireless device 1605. In the implementation illustrated in FIG. 17, the second channel sounding is transmitted as a second null data packet NDP₂ 1714 at time t₆. As described above, in some implementations, although not shown in FIG. 15, the process 1500 can additionally include transmitting, by the first wireless device 1602, a second NDPA before transmitting the second null data packet NDP₂. For example, FIG. 17 shows a second NDPA₂ 1712 transmitted at time t₅ before NDP₂ 1714 is transmitted at time t₆.

As described above, each of the beamformees—the second and the third wireless devices 1604 and 1605—estimates the channel associated with the NDP₂ 1714 by analyzing the non-legacy LTFs in NDP₂ 1714. As is also described above, in some implementations, the second and the third wireless devices 1604 and 1605, respectively, perform SVD on the channels corresponding to the second channel sounding NDP₂ 1714 and transmit as second channel feedback the values of the S and V matrices to the first wireless device 1602 in a compressed form. FIG. 17 shows the second wireless device 1604 transmitting compressed feedback CBF_{2,1} 1716 at time t₇. In some implementations, the compressed feedback CBF_{2,1} 1716 is transmitted in the form of a compressed beamforming report frame. To obtain the second channel feedback from the third wireless device 1605, the first wireless device 1602 transmits a second beamforming report poll frame BRP₂ 1718 at time t₈. In response to the beamforming report poll frame BRP₂ 1718, the third wireless device 1605 transmits compressed feedback CBF_{2,2} 1720 at time t₉.

If the first wireless device 1602 determines, in block 1514, that all soundings have been transmitted, the process 1500 proceeds in block 1516 with the first wireless device 1602 combining the channel feedback received based on the multiple soundings. For example, as is also described above, in some implementations, to combine the channel feedback of each user in block 1516, the first wireless device 1602 is configured to perform a QR decomposition operation as described above with reference to FIG. 12. The first wireless device 1602 generates a steering matrix to be applied to the packets for the multiple users based on the combined channel feedbacks in block 1518. The process 1500 then proceeds in block 1520 with the first wireless device 1602 transmitting a beamformed communication to each of the second and the third wireless devices 1604 and 1605 simultaneously based on the steering matrix. FIG. 17 shows the first wireless device 1602 transmitting the combined beamformed communication 1722 at time t₁₀.

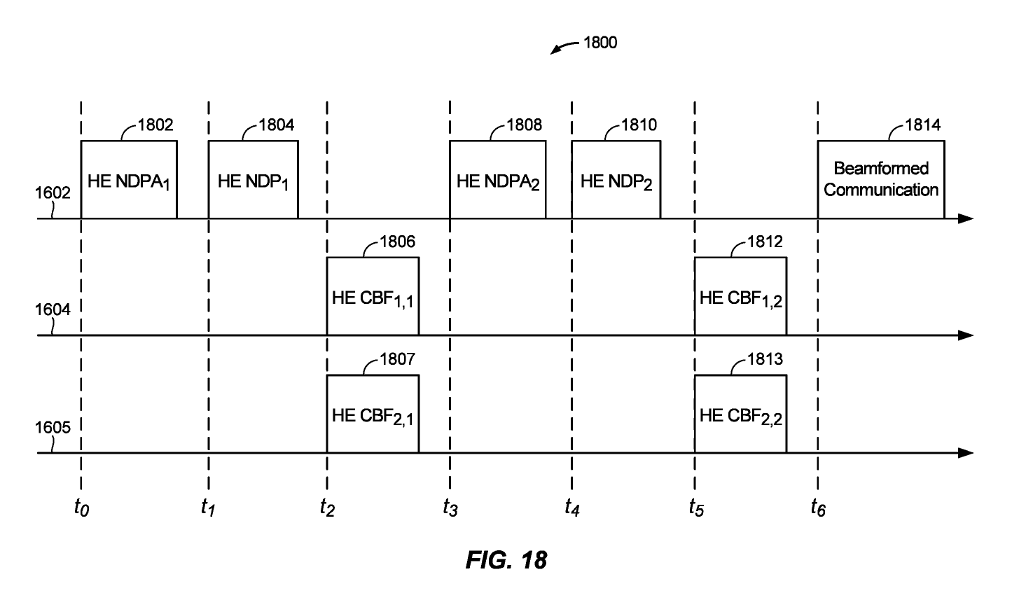

FIG. 18 shows a timing diagram 1800 for another example multi-user beamforming operation according to some implementations. The multi-user beamforming operation described with reference to the timing diagram 1800 of FIG. 18 also can be representative of the implementations illustrated and described with reference to FIGS. 15 and 16A-16C. The timing diagram 1800 of FIG. 18 is similar to the timing diagram 1700 of FIG. 17 except that the multi-user beamforming operation of FIG. 18 utilizes high efficiency (HE) WLAN (HEW) frames structured in accordance with the IEEE 802.11ax amendment to the IEEE 802.11 set of standards. For example, in the implementation illustrated in FIG. 18, the first wireless device 1602 transmits the first NDP announcement frame as a first high efficiency NDP announcement frame HE NDPA₁ 1802 at time t₀. The first wireless device 1602 subsequently transmits the first channel sounding as a high efficiency (HE) null data packet NDP₁ 1804 at time t₁.

As described above, each of the beamformees—the second and the third wireless devices 1604 and 1605—estimates the channel associated with the HE NDP 1804 by analyzing the non-legacy LTFs in NDP₁ 1804 and provides channel feedback based on the estimation. FIG. 18 shows the second and third wireless devices 1604 and 1605 transmitting compressed feedback CBF_{1,1} 1806 and CBF_{2,1} 1807, respectively, at time t₂. As described above, in some implementations, the compressed feedback CBF_{1,1} 1806 and CBF_{2,1} 1807 are transmitted in the form of compressed beamforming report frames. In contrast to the implementation described with reference to FIG. 17, in the implementation illustrated with respect to FIG. 18 both the second wireless device 1604 and the third wireless device 1605 transmit their channel feedback simultaneously without the use of any beamforming report poll frames.

The first wireless device 1602 then transmits the second NDP announcement frame as a second HE NDP announcement frame HE NDPA₂ 1808 at time t₃. The first wireless device 1602 subsequently transmits the second channel sounding as a second high efficiency null data packet HE NDP₂ 1810 at time t₄. As described above, each of the beamformees—the second and the third wireless devices 1604 and 1605—estimates the channel associated with the HE NDP₂ 1810 by analyzing the non-legacy LTFs in NDP₂ 1810 and provides channel feedback based on the estimation. FIG. 18 shows the second and third wireless devices 1604 and 1605 transmitting compressed feedback CBF_{1,2} 1812 and CBF_{2,2} 1813, respectively, at time t₅. As described above, in some implementations, the compressed feedback CBF_{1,2} 1812 and CBF_{2,2} 1813 are transmitted in the form of compressed beamforming report frames. Again, in contrast to the implementation described with reference to FIG. 17, in the implementation illustrated with respect to FIG. 18 both the second wireless device 1604 and the third wireless device 1605 transmit their channel feedback simultaneously without the use of any beamforming report poll frames.

The multi-user beamforming operation then proceeds with the first wireless device 1602 transmitting beamformed communications to the second and the third wireless devices 1604 and 1605 simultaneously using the steering matrix generated based on the combined first and second channel feedback from each of the first and the second wireless devices. FIG. 18 shows the first wireless device 1602 transmitting the beamformed communications 1814 at time t₆.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for wireless communication:
transmitting, by a first wireless device, a first channel sounding using a first subset of a set of transmit antennas of the first wireless device;
receiving, by the first wireless device, first channel feedback from a second wireless device based on the first channel sounding;
transmitting, by the first wireless device, a second channel sounding using a second subset of the set of transmit antennas, the second subset partially overlapping with the first subset;
receiving, by the first wireless device, second channel feedback from the second wireless device based on the second channel sounding; and
transmitting, by the first wireless device, a beamformed communication to the second wireless device based on the first and the second channel feedback.

2. The method of claim 1, further including receiving channel estimation capability information from the second device indicating a number N_{CEC} of channels the second wireless device can estimate, wherein each of the first and the second subsets of transmit antennas includes N_{CEC} transmit antennas.

3. The method of claim 2, wherein the first and the second subsets of transmit antennas share a number N_{OVER} of overlapping transmit antennas, and wherein N_{OVER} is equal to a number N_{R} of receive antennas of the second wireless device.

4. The method of claim 2, further including determining a number of channel soundings to transmit based on a number N_{T} of transmit antennas of the first wireless device, the number N_{CEC} of channels the second wireless device can estimate, and a number N_{OVER} of overlapping transmit antennas shared between the first and the second subsets of transmit antennas.

5. The method of claim 1, further including combining, by the first wireless device, the first and the second channel feedback to generate a combined channel matrix.

6. The method of claim 5, wherein combining the first and the second channel feedback includes determining first and second channel matrices for the first and the second channel soundings, respectively, based on the first and the second channel feedback, respectively.

7. The method of claim 6, wherein combining the first and the second channel feedback further includes determining overlapping sub-matrices and non-overlapping sub-matrices of the first and the second channel matrices.

8. The method of claim 7, wherein combining the first and the second channel feedback further includes applying a QR decomposition operation to each of the overlapping sub-matrices to determine a matrix Q associated with each of the overlapping sub-matrices and to determine a right triangular matrix R.

9. The method of claim 8, wherein the combined channel matrix is generated based on the non-overlapping sub-matrices, the Q matrices and the R matrix.

10. The method of claim 5, further including generating a beamforming steering matrix based on the combined channel matrix, wherein the beamformed communication is transmitted based on the beamforming steering matrix.

11. An apparatus comprising:
means for transmitting a first channel sounding using a first subset of a set of transmit antennas;
means for receiving first channel feedback from a second wireless device based on the first channel sounding;
means for transmitting a second channel sounding using a second subset of the set of transmit antennas, the second subset partially overlapping with the first subset;
means for receiving second channel feedback from the second wireless device based on the second channel sounding; and
means for transmitting a beamformed communication to the second wireless device based on the first and the second channel feedback.

12. The apparatus of claim 11, further including means for receiving channel estimation capability information from the second device indicating a number N_{CEC} of channels the second wireless device can estimate, wherein each of the first and the second subsets of transmit antennas includes N_{CEC} transmit antennas.

13. The apparatus of claim 12, wherein the first and the second subsets of transmit antennas share a number N_{OVER} of overlapping transmit antennas, and wherein N_{OVER} is equal to a number N_{R} of receive antennas of the second wireless device.

14. The apparatus of claim 12, further including means for determining a number of channel soundings to transmit based on a number N_{T} of transmit antennas of the first wireless device, the number N_{CEC} of channels the second wireless device can estimate, and a number N_{OVER} of overlapping transmit antennas shared between the first and the second subsets of transmit antennas.

15. The apparatus of claim 11, further including means for combining the first and the second channel feedback to generate a combined channel matrix.

16. The apparatus of claim 15, wherein the means for combining the first and the second channel feedback includes means for determining first and second channel matrices for the first and the second channel soundings, respectively, based on the first and the second channel feedback, respectively.

17. The apparatus of claim 16, wherein the means for combining the first and the second channel feedback further includes means for determining overlapping sub-matrices and non-overlapping sub-matrices of the first and the second channel matrices.

18. The apparatus of claim 17, wherein the means for combining the first and the second channel feedback further includes means for applying a QR decomposition operation to each of the overlapping sub-matrices to determine a matrix Q associated with each of the overlapping sub-matrices and to determine a right triangular matrix R.

19. The apparatus of claim 18, wherein the combined channel matrix is generated based on the non-overlapping sub-matrices, the Q matrices and the R matrix.

20. The apparatus of claim 15, further including means for generating a beamforming steering matrix based on the combined channel matrix, wherein the beamformed communication is transmitted based on the beamforming steering matrix.

21. A wireless access point comprising:
a plurality of antennas;
a processor; and
a memory communicatively coupled with the processor and storing computer-readable code that, when executed by the processor, causes the wireless access point to:
transmit a first channel sounding using a first subset of the antennas;
receive first channel feedback from a second wireless device based on the first channel sounding;
transmit a second channel sounding using a second subset of the antennas, the second subset partially overlapping with the first subset;
receive second channel feedback from the second wireless device based on the second channel sounding; and
transmit a beamformed communication to the second wireless device based on the first and the second channel feedback.

22. The access point of claim 21, further including code to receive channel estimation capability information from the second device indicating a number N_{CEC} of channels the second wireless device can estimate, wherein each of the first and the second subsets of antennas includes N_{CEC} antennas.

23. The access point of claim 22, wherein the first and the second subsets of antennas share a number N_{OVER} of overlapping antennas, and wherein N_{OVER} is equal to a number N_{R} of receive antennas of the second wireless device.

24. The access point of claim 22, further including code to determine a number of channel soundings to transmit based on a number N_{T} of antennas of the first wireless device, the number N_{CEC} of channels the second wireless device can estimate, and a number N_{OVER} of overlapping antennas shared between the first and the second subsets of antennas.

25. The access point of claim 21, further including code to combine the first and the second channel feedback to generate a combined channel matrix.

26. The access point of claim 25, wherein the code to combine the first and the second channel feedback includes code to determine first and second channel matrices for the first and the second channel soundings, respectively, based on the first and the second channel feedback, respectively.

27. The access point of claim 26, wherein the code to combine the first and the second channel feedback further includes code to determine overlapping sub-matrices and non-overlapping sub-matrices of the first and the second channel matrices.

28. The access point of claim 27, wherein the code to combine the first and the second channel feedback further includes code to apply a QR decomposition operation to each of the overlapping sub-matrices to determine a matrix Q associated with each of the overlapping sub-matrices and to determine a right triangular matrix R.

29. The access point of claim 28, wherein the combined channel matrix is generated based on the non-overlapping sub-matrices, the Q matrices and the R matrix.

30. The access point of claim 25, further including code to generate a beamforming steering matrix based on the combined channel matrix, wherein the beamformed communication is transmitted based on the beamforming steering matrix.
